(19) United States
(12) Patent Application Publication
(10) Pub. No.: US 2010/0011287 A1
(43) Pub. Date: Jan. 14, 2010

(54) APPARATUS AND METHOD FOR EDITING DOCUMENT LAYOUT AND STORAGE MEDIUM

(75) Inventor: Hitoshi Osaka, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/500,494

(22) Filed: Jul. 9, 2009

(30) Foreign Application Priority Data
Jul. 11, 2008 (JP) 2008-182046

(51) Int. Cl. G06F 17/24

(52) U.S. Cl. 715/251

(57) ABSTRACT

The distances between adjacent objects on a document are extracted. Next, the plurality of extracted distances are grouped on the basis of a value based on the horizontal (lateral) position of a distance-adjustment graphical user interface; the plurality of distances are unified to a representative value based on the vertical position of the distance-adjustment graphical user interface. Next, the objects are rearranged (subjected to relayout) so that the distance between the adjacent objects on the document becomes the representative value.

### BACKGROUND OF THE INVENTION

1. Field of the Invention

The present invention relates to an apparatus and a method for editing document layout, as well as a computer program, and in particular, those suitable for editing the layout of objects arranged in a document.

2. Description of the Related Art

A known page layout technology in the related art adjusts the spacing between characters and lines of “an imaged document” captured from different sentences (refer to Japanese Patent Laid-Open No. 5-108793). Another known technology adjusts the distance between a plurality of text objects so that the text objects appear as continuous paragraphs when laid out (refer to Japanese Patent Laid-Open No. 2004-295864.

In page layout, the uniformity of object layout has a close connection with a great-looking layout of a document. In particular, the uniformity of the distances between objects has a close connection with a great-looking layout of a document. In the case where various objects are arranged in a document, unevenness of the distances between the objects on a page results in a bad-looking document. That is, to obtain a great-looking document, the distances between the objects on a page need to be designed on the basis of a certain rule.

Examples of a method for laying out objects on a page include a method using a drawing application, such as Adobe Illustrator, and a method for laying out portable document format (PDF) data that is converted from an existing document using an application, such as Adobe Acrobat after dividing it into objects.

The former method requires the user to lay out various objects with attention to the distances between the objects.

On the other hand, the latter method can cause a plurality of different rules to coexist when a plurality of documents are merged after one document is captured even if the distances between the objects conform to a certain rule. For example, in consideration of a technology to move objects across the boundary of pages to merge a plurality of documents every page, a plurality of rules can coexist in the same page. This can cause ununiformity of rules for the distances between objects.

Thus, a solution for unifying the rules for the distances between the objects in a document is required.

The above-described technology disclosed in Japanese Patent Laid-Open No. 5-108793 can make the distances between character strings in a document captured as an image equal. However, in document expression, in general, it is necessary not to simply make all the intervals equal but to intentionally differentiate the intervals between the objects, such as the interval between a title character string and the paragraphs of the body and the interval between the paragraphs of the body and an illustration. This differentiation is made rules for the distances between the objects in e document. The technology described in Japanese Patent Laid-Open No. 5-108793 cannot differentiate the distances between a plurality of objects in this way.

Also in the above-described technology disclosed in Japanese Patent Laid-Open No. 2004-295864, only the visual continuity of the space between the lines of character objects is in question, and the problem of uniformity of rules for the distances between objects in the entire document cannot be solved.

To unify the rules for the distances between objects without using the technologies disclosed in Japanese Patent Laid-Open No. 5-108793 and Japanese Patent Laid-Open No. 2004-295864, a user is required to directly editing the objects by hand to adjust the positions using an application, as described above.

However, the operation to select individual objects and change the positions thereof is complicated. Furthermore, designing a unified layout requires a skilled layout technique.

To capture a document and convert it to PDF data, it is desirable to redesign the entire layout without greatly breaking the rules for the distances between the objects that the original document layout has, because also the original document should have an intention in layout. However, such a correcting work is significantly complicated and difficult.

### SUMMARY OF THE INVENTION

The present invention is made in consideration of the above-described problems. The present invention can adjust the distances between objects on a document more easily than related art.

A document-layout editing apparatus according to an aspect of the present invention includes an extracting unit configured to extract the distances between adjacent objects on a document; a collecting unit configured to collect the plurality of distances into one or a plurality of groups on the basis of the difference between the plurality of distances extracted by the extracting unit; a unifying unit configured to unify the distances collected by the collecting unit to a representative value; and a changing unit configured to change the layout of the objects so that the distances between the adjacent objects on the document become the representative value corresponding to the distances.

Further features of the present invention will become apparent from the following description of exemplary embodiments (with reference to the attached drawings).

### BRIEF DESCRIPTION OF THE DRAWINGS

FIG. 1 shows a first embodiment of the present invention, showing an example of the configuration of a system having a document-layout editing apparatus that performs page layout.

FIG. 2 shows the first embodiment of the present invention, showing an example of an object list.

FIG. 3 shows the first embodiment of the present invention, showing an example of the relationship between object information stored in the object list and an actual object.

FIG. 4 shows the first embodiment of the present invention, showing an example in which a rectangular object, as shown in FIG. 3, is read from a PDF-format document, and information on the object is extracted.

FIG. 5 shows the first embodiment of the present invention, showing a flowchart describing an example of processing by a layout processing section of the document-layout editing apparatus when grouping objects into blocks.

FIG. 6 shows the first embodiment of the present invention, illustrating an example of the vertical distance between two objects.

FIG. 7 shows the first embodiment of the present invention, showing a document and an example of the result of grouping the objects of the document into blocks according to the flowchart in FIG. 5.

FIG. 8 shows the first embodiment of the present invention, showing an example of a page layout of a document whose layout is to be changed.

FIG. 9 shows the first embodiment of the present invention, showing an example of the correspondence between the indexes of the vertical distances between the objects shown in FIG. 8 and the vertical distances of actual objects in a tabular form.

FIG. 10 shows the first embodiment of the present invention, showing an example of a dendrogram generated from the distances between the objects on the page layout shown in FIG. 8.

FIG. 11 shows the first embodiment of the present invention, showing an example of a distance-adjustment graphical user interface (GUI) for changing layout.

FIGS. 12A to 12D show the first embodiment of the present invention, showing a state in which the page layout shown in FIG. 8 is changed by a lateral operation on the distance-adjustment graphical user interface and a first example of pairs that are unified at the individual operation states.

FIGS. 13A to 13C show the first embodiment of the present invention, showing a state in which the page layout shown in FIG. 8 is changed by a lateral operation on the distance-adjustment graphical user interface and a second example of pairs that are unified at the individual operation states.

FIGS. 14A to 14D show the first embodiment of the present invention, showing a state in which the page layout in FIG. 8 is changed by a vertical operation to the center and a lateral operation on the distance-adjustment graphical user interface and a first example of pairs of distances that are unified at the individual operation states.

FIGS. 15A to 15C show the first embodiment of the present invention, showing a state in which the page layout in FIG. 8 is changed by a vertical operation to the center and a lateral operation on the distance-adjustment graphical user interface and a second example of pairs of distances that are unified at the individual operation states.

FIGS. 16A to 16D show the first embodiment of the present invention, showing a state in which the page layout shown in FIG. 8 is changed by a vertical downward operation and a lateral operation on the distance-adjustment graphical user interface and a first example of pairs of distances that are unified at the individual operation state.

FIGS. 17A to 17C show the first embodiment of the present invention, showing a state in which the page layout shown in FIG. 8 is changed by a vertical downward operation and a lateral operation on the distance-adjustment graphical user interface and a second example of pairs of distances that are unified at the individual operation state.

FIG. 18 shows the first embodiment of the present invention, showing a flowchart that describes an example of the processing of the document-layout editing apparatus when changing the page layout by changing the distances between the objects.

FIG. 19 shows the first embodiment of the present invention, showing a flowchart that describes in detail an example of the cluster analysis processing in step S1805 of FIG. 18.

FIG. 20 shows the first embodiment of the present invention, showing a flowchart that describes in detail an example of the relayout processing in step S1807 of FIG. 18.

FIG. 21 shows the first embodiment of the present invention, showing an example of the structure of a list in which information on object blocks and distances.

FIG. 22 shows the first embodiment of the present invention, showing an example of the structure of a list in which information on clusters is collected.

FIG. 23 shows a second embodiment of the present invention, showing a flowchart describing in detail an example of the relayout processing in step S1807 of FIG. 18.

FIG. 24 shows the second embodiment of the present invention, showing is a conceptual diagram of an example of a state in which an object block is rearranged across the page boundary.

FIG. 25 shows the second embodiment of the present invention, showing an example of the structure of a list in which information on the object blocks and the distances of all the pages of the document is listed.

FIG. 26 shows a third embodiment of the present invention, showing an example of the functional configuration of a computer module and a local printer.

FIG. 27 shows the third embodiment of the present invention, showing an example of a distance-adjustment graphical user interface.

FIG. 28 shows the third embodiment of the present invention, showing a flowchart describing an example of the process of a printer driver in the document-layout editing apparatus when changing a page layout by changing the distances between objects.

FIG. 29 shows a fourth embodiment of the present invention, showing an example of a print system equipped with an image forming apparatus.

FIG. 30 shows the fourth embodiment of the present invention, showing an example of the appearance configuration of the image forming apparatus.

FIG. 31 shows the fourth embodiment of the present invention, showing an example of the functional configuration of the image forming apparatus.

FIG. 32 shows the fourth embodiment of the present invention, showing an example of the configuration of a controller unit of the image forming apparatus in more detail.

### DESCRIPTION OF THE EMBODIMENTS

First, terms used in the present invention will be described before embodiments of the present invention are described. Firstly, “page” in the present invention refers to a limited region, such as an A4-sheet, where content is to be described. Secondly, “object” in the present invention refers to a pictorial element that can be handled independently, such as a figure, a character string, an image, or a combination thereof.

### First Embodiment

A first embodiment of the present invention will be described hereinbelow with reference to the drawings.

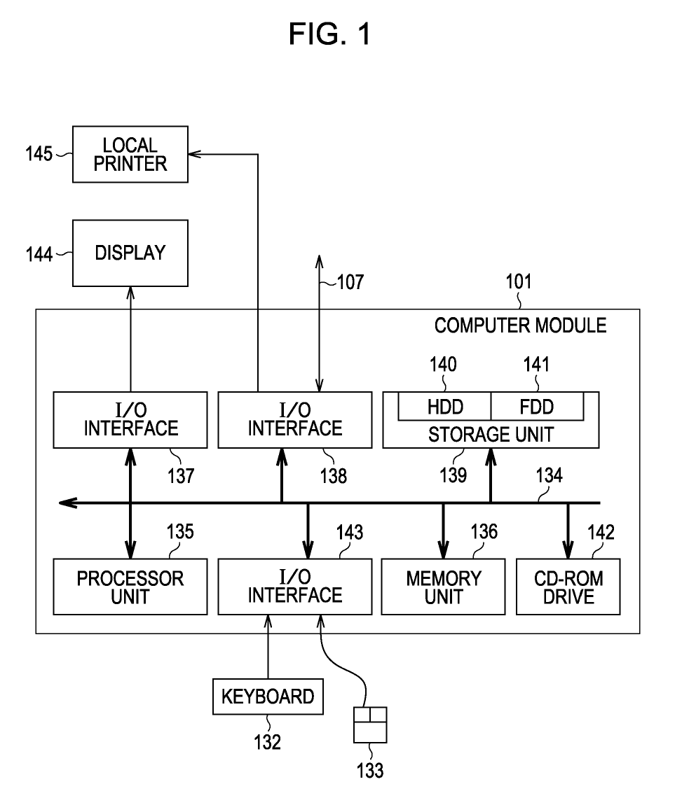

FIG. 1 is a diagram showing an example of a system configuration having a document-layout editing apparatus that performs page layout.

In FIG. 1, a computer module 101 connects to input units, such as a keyboard 132 and a pointing device, like a mouse 133, via an input/output interface (I/O interface) 143. The computer module 101 also connects to output units, such as a display 144 and a local printer 145 depending on the circumstances. An input/output interface (I/O interface) 138 connects the computer module 101 to a network 107 to allow the computer module 101 to communicate with an external computer unit. Examples of the network 107 are a local area network (LAN), a wide area network (WAN), and the Internet.

The computer module 101 includes at least one processor unit (CPU) 135. The computer module 101 also includes a memory unit 136 equipped with a semiconductor random access memory (RAM) or a read-only memory (ROM), for example. The computer module 101 also has an input/output (I/O) interface including a video interface 137 and the I/O interface 143 for connecting the keyboard 132 and the mouse 133 with the computer module 101 to each other.

Furthermore, the computer module 101 has a storage unit 139 including a hard disk drive (HDD) 140 and a flexible disk drive (FDD) 141, for example. Although not shown in FIG. 1, a magnetic tape drive etc. are sometimes included in the storage unit 139. A CD-ROM drive 142 is provided as a nonvolatile data source.

The computer module 101 executes processing using an operation system, such as LINUX (a registered trademark) or WINDOWS (a registered trademark), or the components 135 to 143 of the computer module 101 which perform communications via an interconnection bus 134.

Software for achieving the procedures shown in the flowcharts below is stored in “a readable medium in the computer module 101” including the storage unit 139, for example. The software is loaded from the readable medium in the computer module 101 into the memory unit 136 and is executed by the processor unit (CPU) 135. When the computer module 101 uses a computer program product, the document-layout editing apparatus can be operated as an apparatus useful for editing document layout.

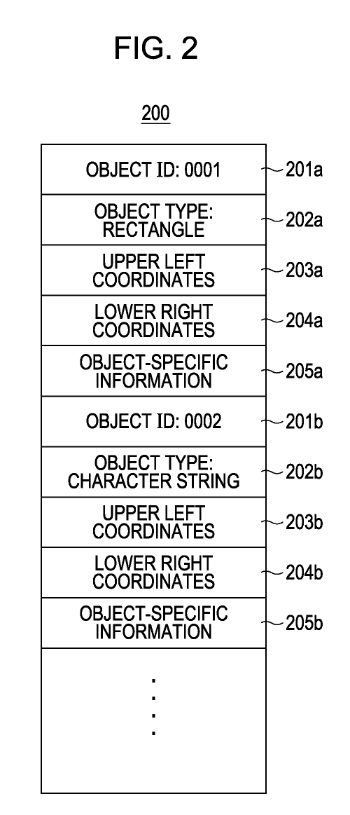

FIG. 2 is a diagram showing an example of an object list.

An object list 200 shown in FIG. 2 is stored in, for example, the HDD 140. In this embodiment, the computer module 101 manages information on objects in a document using the object list 200, as shown in FIG. 2. As shown in FIG. 2, information on the objects is stored in a list structure in the object list 200. Information on each object includes an object ID 201, an object type 202, upper left coordinates 203, lower right coordinates 204, and object-specific information 205. Here, the upper left coordinates 203 and the lower right coordinates 204 are information indicating the position of the object.

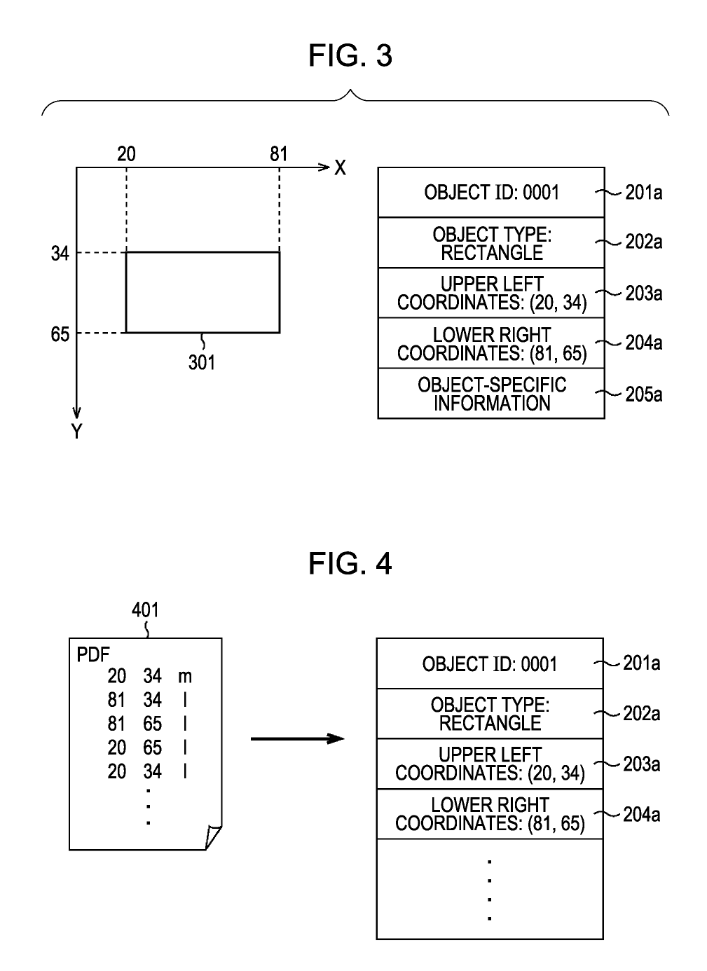

FIG. 3 is a diagram showing an example of the relationship between object information stored in the object list 200 and an actual object.

As shown in FIG. 3, information on a rectangular object 301 whose upper left coordinates 203 are (20, 34) and lower right coordinates 204 are (81, 65) is stored (registered) in the object list 200 as in the right figure of FIG. 3.

FIG. 4 is a conceptual diagram showing an example in which the rectangular object 301, as shown in FIG. 3, is read from a PDF-format document 401, and information on the object 301 is extracted.

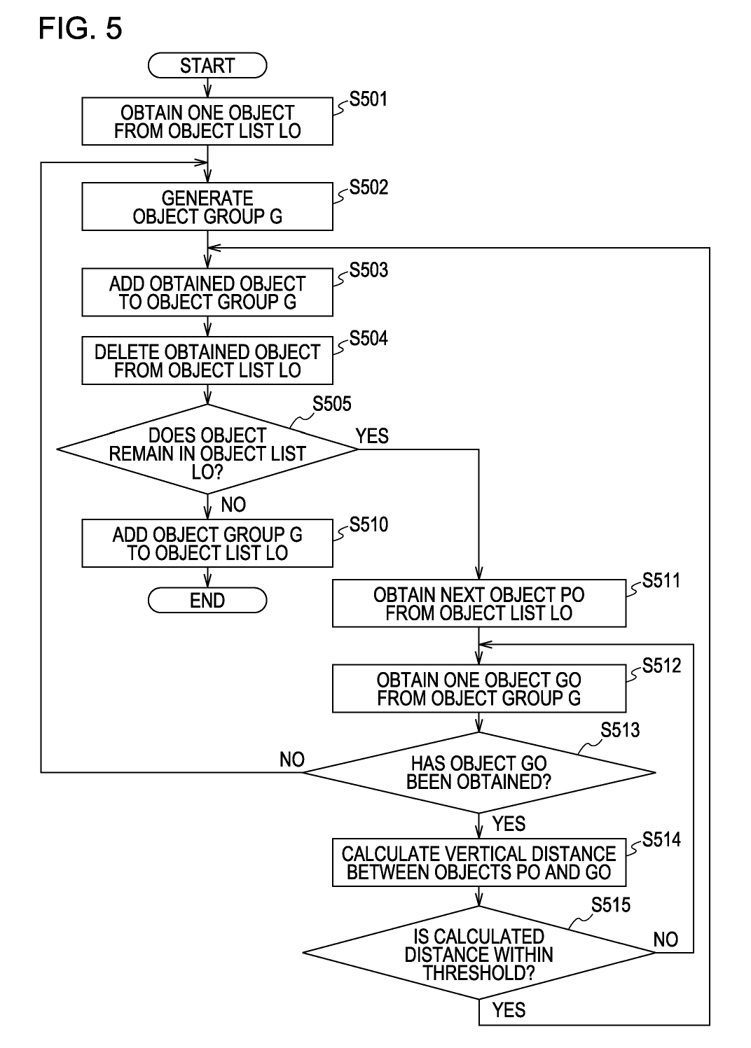

FIG. 5 is a flowchart describing an example of processing of a layout processing section of the document-layout editing apparatus when grouping objects used in this embodiment into blocks. In this embodiment, the layout processing section can be achieved using the processor unit (CPU) 135, the memory unit 136, the CD-ROM drive 142, the HDD 140, etc. The procedure shown in the flowchart in FIG. 5 is stored in either the memory unit (RAM or ROM) 136 or the HDD 140 and is executed by the processor unit (CPU) 135.

First, in step S501, the layout processing section obtains an object from an object list LO. An example of the object list LO is the object list 200 shown in FIG. 2.

Next, in step S502, the layout processing section generates a new object group G. Here, the object group G has the same format as that of the object list LO and has a data format that allows the layout processing section to operate it as one object.

Next, in step S503, the layout processing section adds the object obtained in step S501 to the generated object group G.

Next, in step S504, the layout processing section deletes the object added to the object group G from the object list LO.

Next, in step S505, the layout processing section determines whether an object remains in the object list LO. If it is determined that no object remains in the object list LO, the process moves to step S510. In step S510, the layout processing section adds the object group G to the object list LO. Then, the process of the flowchart in FIG. 5 is terminated.

On the other hand, if an object remains in the object list LO, the process moves to step S511. In step S511, the layout processing section obtains the next object PO from the object list LO.

Next, in step S512, the layout processing section obtains one object GO in the object group G.

Next, in step S513, the layout processing section determines whether the object GO has been obtained from the object group G. If it is determined that the object GO could not obtained from the object group G, the process returns to step S502, described below.

On the other hand, if the object GO could be obtained from the object group G, the process moves to step S514. In step S514, the layout processing section calculates the vertical distance between the object PO obtained in step S511 and the object GO obtained in step S512.

FIG. 6 is a diagram illustrating an example of the vertical distance between the two objects.

As shown in FIG. 6, in this embodiment, the distance between the objects refers to the shortest distance between circumscribed rectangles that enclose objects 601 and 602. In the example shown in FIG. 6, the object 601 is a rectangular object, while the object 602 is an elliptic object. Accordingly, the layout processing section forms a circumscribed rectangle 603 of the elliptic object 602 and calculates the shortest distance 604 between the circumscribed rectangle 603 and the rectangular object 601 as the vertical distance between the two objects 601 and 602.

Referring back to FIG. 5, in step S515, the layout processing section determines whether the distance calculated in step S514 falls within a threshold. If it is determined that the distance calculated in step S514 does not fall within the threshold, the process returns to step S512, described above. On the other hand, if the distance calculated in step S514 falls within the threshold, the process returns to step 503, described above.

The threshold here indicates a specified distance determined for the system. In this embodiment, the objects grouped into blocks are separated in the vertical direction using the threshold of the distance.

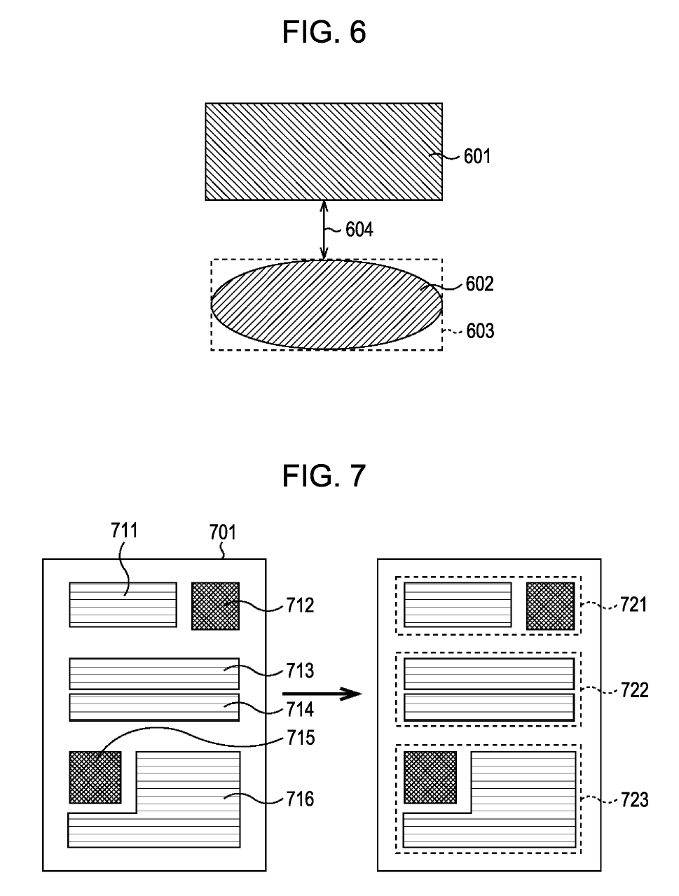

FIG. 7 is a diagram showing a document and an example of the result of grouping the objects of the document into blocks according to the flowchart in FIG. 5.

As shown in FIG. 7, an object 711 and an object 712 are grouped into one block 721 on a page 701. Likewise, an object 713 and an object 714 are grouped into a block 722, and an object 715 and an object 716 are grouped into a block 723. Since the object 711 and the object 712 are next to each other, the vertical difference between them is regarded as zero. As a result, the vertical difference therebetween falls within a threshold, so that they are grouped into one block.

As shown in FIG. 7, this embodiment is configured such that, in changing the page layout, not all the distances between the smallest-block objects but “the distance between blocks” consisting of a certain object group is considered. Thus, this embodiment will be described using an example in which blocks are changed in the process of changing (setting) the page layout. In the present invention, “object” also includes “block (hereinafter also referred to as an object block)” in which a plurality of blocks are collected together, as shown in FIG. 7.

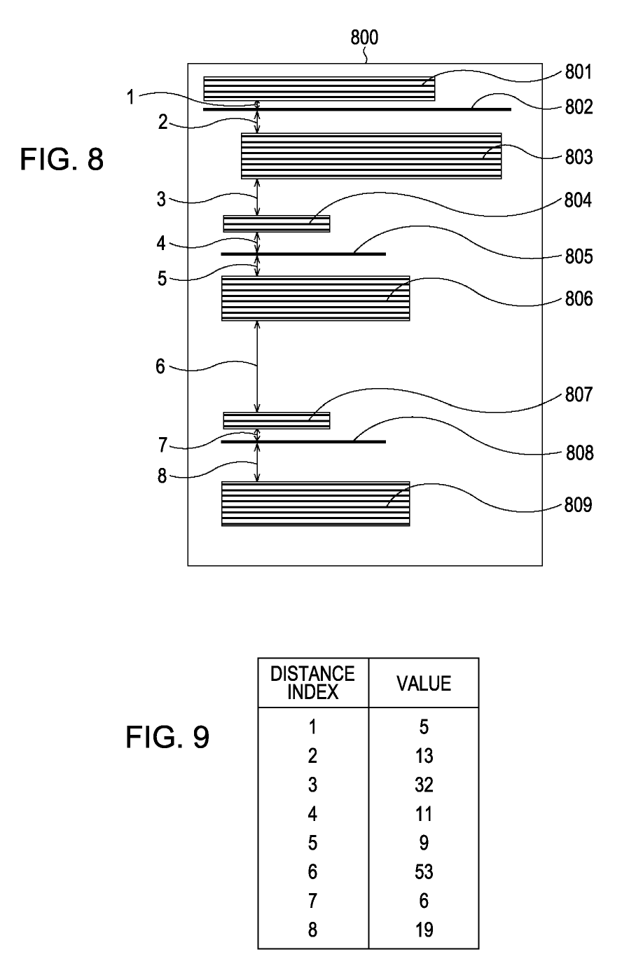

FIG. 8 is a diagram showing an example of a page layout of a document whose layout is to be changed. As shown in FIG. 8, the (vertical) distances between the objects on a page 800 vary. Objects 801 to 809 (objects formed in a block are also referred to as an object, as described above) are arranged on the page 800. Distances 1 to 8 are present in the vertical direction between the objects 801 and 809. Since the page layout shown in FIG. 8 has no unified positive rule between the distances 1 to 8, the appearance of the document is damaged.

FIG. 9 is a diagram showing an example of the correspondence between the indexes of the vertical distances between the objects shown in FIG. 8 and the vertical distances of actual objects in a tabular form.

This embodiment will be described using an example in which the varying distances 1 to 8 between the objects in FIG. 8 are made into one or more distances according to a rule using “hierarchical cluster analysis”. Because the cluster analysis is a known technology, its detailed description will be omitted; the hierarchical cluster analysis adopts the idea of grouping a plurality of items using a graph called a dendrogram (treelike diagram. The dendrogram is a treelike diagram illustrating connection levels between clusters that are elements and a element group.

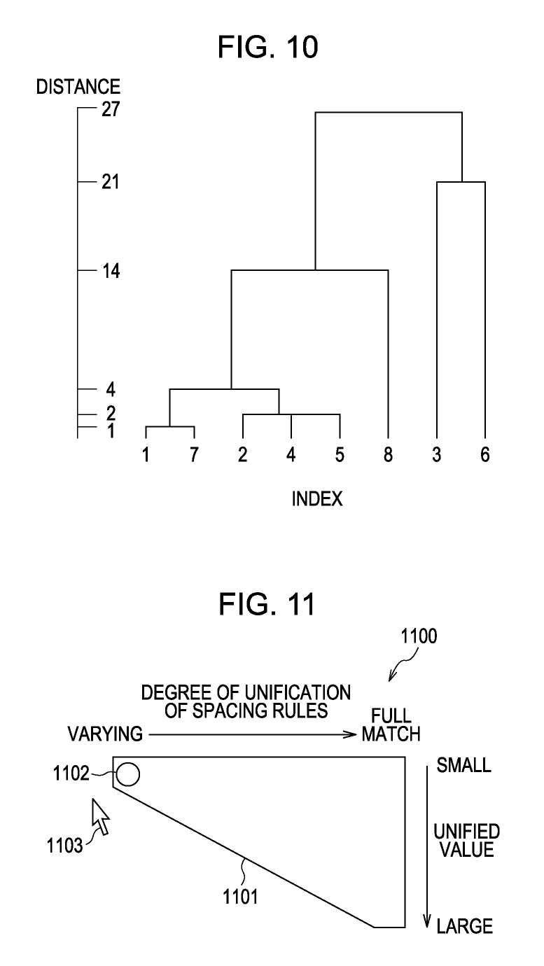

FIG. 10 is a diagram showing an example of a dendrogram generated from the distances 1 to 8 between the objects on the page layout shown in FIG. 8.

The distances 1 to 8, described above, are arranged as indexes at the lower part in FIG. 10. The vertical axis of the dendrogram is the distance between the objects. For example, referring to FIGS. 8 and 9, the difference between distance 1 and distance 7 is only “1”, so that the distances 1 and 7 can be regarded as one group having the closest value. Thus, as shown in FIG. 10, the two indexes of distances 1 and 7 form the first group (cluster 1). The next closest distances are distance 2 and distance 4, and distance 4 and distance 5, both of which have a difference “2”. Thus, the three indexes of distances 2, 4, and 5 form a new group (cluster 2).

In the cluster analysis, “a representative value” is assigned to a formed cluster. For example, as a representative value that represents the cluster 1 composed of distance 1 and distance 7, a value “5”, which is the smaller of the values of distance 1 and distance 7, may be adopted, or alternatively, the larger value “6” may be adopted. As another alternative, a value “5.5”, which is the mean value of the values of distance 1 and distance 7, may be adopted as the representative value.

Furthermore, as in the dendrogram shown in FIG. 10, the number of the indexes of distances to be unified can be increased in sequence, such as that the cluster 1 and the cluster 2 are unified to form a cluster 3, and then the cluster 3 and distance 8 are unified. To what extent the distances are to be unified should be selected by a user. If all the distances are completely unified, distances that the user wanted to make different are also unified, resulting in a monotonous page layout. Accordingly, it is an object of the embodiment to separately unify groups having some close distance values and to leave groups having a large difference in distance value as they are without unification.

The above will be described with reference to the page layout shown in FIG. 8. Since the distance 1 and the distance 7 have close values, they can be the first candidate for unification. Thus, if they are unified, one variation in distance in the document will be decreased. At that time, there is a problem to which value the distances should be unified. Here, the above-described “representative value” of the cluster is used. The representative value should be selected by the user when the layout is adjusted. Likewise, the distance 2 and the distance 4, and the distance 4 and the distance 5 are close values. Therefore, if they are unified, variations in distance are decreased, so that the appearance of the layout is improved. However, this also poses a problem that is referred to the user, that is, to which of the three values the distances should be unified. Thus, a second object of this embodiment is to unify the distances by user's selection while considering the values of the distances present in the original page layout.

FIG. 11 is a diagram showing an example of a distance-adjustment graphical user interface (GUI) for changing layout. In this embodiment, the above-described two objects of this embodiment can be achieved using a distance-adjustment graphical user interface 1100.

In an example shown in FIG. 11, the user operates a button 1102 that can be moved freely in a user-interface region 1101 with a mouse pointer 1103.

In FIG. 11, the user can control “to what extent the distances are to be unified”, which is the first object, by moving the button 1102 in the lateral direction in the user-interface region 1101. A concrete example thereof will be described. First, in the case where the button 1102 is present at the leftmost of the graphical user interface region 1101, the distances 1 to 8 are in the initial state of the document, that is, the distances 1 to 8 are left varying. On the other hand, in the case where the button 1102 is present at the rightmost of the graphical user interface region 1101, all the distances 1 to 8 are set to one representative value. Furthermore, the distances can be adjusted gradually by moving the button 1102 between the leftmost and rightmost of the graphical user interface region 1101. For example, the width (lateral length) of the graphical user interface region 1101 is divided by the number of levels of the dendrogram (six levels in the example shown in FIG. 10). The crosswise positions of the button 1102 and the levels of the dendrogram are associated with each other so that the user can determine the level in the dendrogram to which the distances should be unified in accordance with the lateral position of the button 1102.

Furthermore, the user can control “to which value close distances should be unified”, which is the second object, by moving the button 1102 in the vertical direction in the graphical user interface region 1101. A concrete example thereof will be described. First, in the case where the button 1102 is present at the uppermost in the graphical user interface region 1101, the smallest of the values of the distances that constitute a cluster is set as a representative value. On the other hand, in the case where the button 1102 is present at the lowermost of the graphical user interface region 1101, the largest of the values of the distances that constitute the cluster is set as a representative value. In the case where the button 1102 is present in the middle between the uppermost and the lowermost of the graphical user interface region 1101, the mean value of the values of the distances that constitute the cluster is set as a representative value.

In this way, this embodiment achieves an example of an operating unit by using the distance-adjustment graphical user interface 1100, for example.

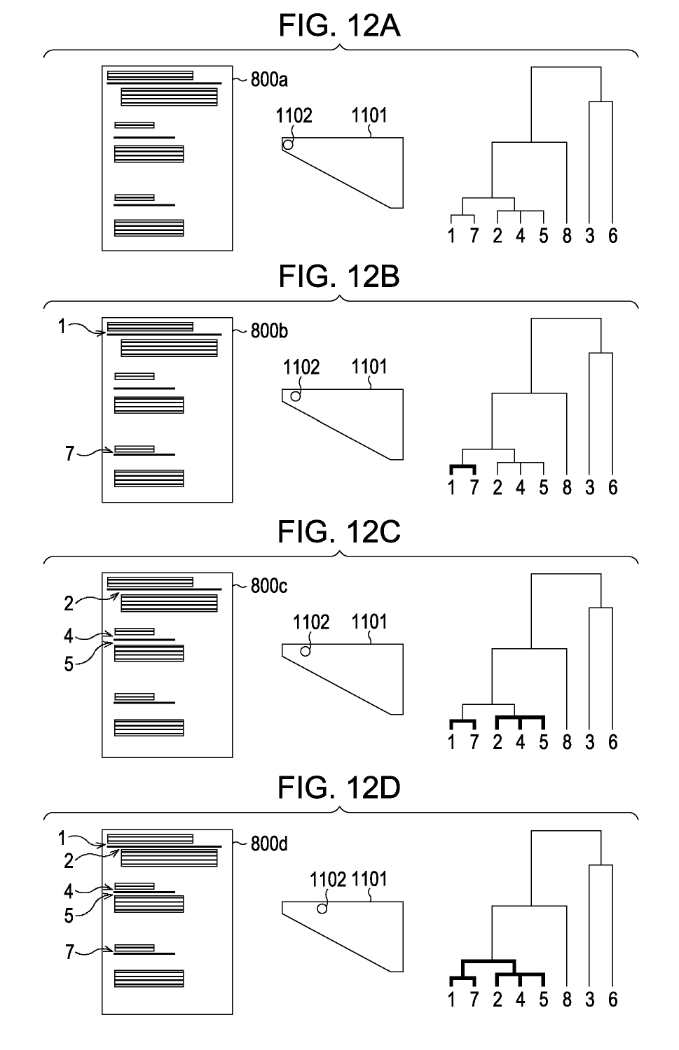

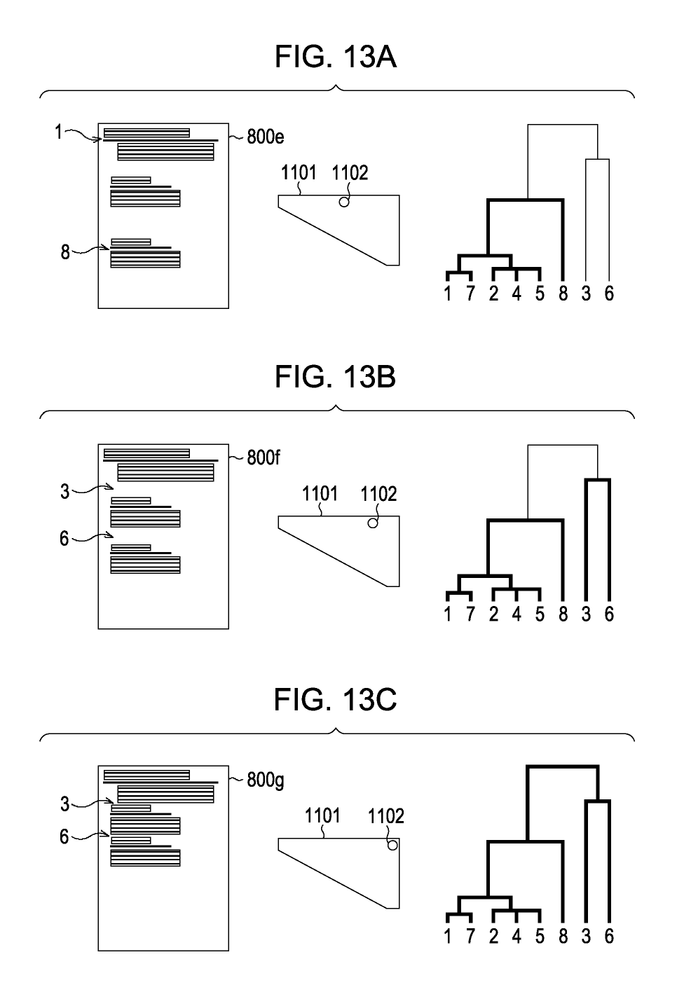

FIGS. 12A to 12D and FIGS. 13A to 13C are diagrams showing a state in which the page layout shown in FIG. 8 is changed by a lateral (horizontal) operation on the distance-adjustment graphical user interface 1100 and an example of pairs that are unified at the individual operation states. FIGS. 12A to 12D and FIGS. 13A to 13C show unified distance pairs with bold lines on the dendrogram.

FIG. 12A shows the initial state, in which the distances between the objects in the document vary.

When the user moves the button 1102 from the initial state shown in FIG. 12A slightly to the right at the upper part on the graphical user interface region 1101, as shown in FIG. 12B, the distances are unified to the first level of the dendrogram. That is, the distances 1 and 7 are unified to the same representative value. Since the button 1102 is located at the upper part, the smaller of the values of the distances 1 and 7 (=5) is used as the representative value, so that the distances 1 and 7 are unified to the representative value (see page 800b).

When the button 1102 is further moved from the state shown in FIG. 12B to the right into the state shown in FIG. 12C, the distances 2, 4, and 5, which are the second layer of the dendrogram, are unified to the same value. Since the button 1102 is located at the upper part, the smallest (=9) of the values of the distances 2, 4, and 5 is used as a representative value, so that the distances 2, 4, and 5 are unified to the representative value (see page 800c). In this way, the user can view the state in which the varying distances between the objects are gradually unified, so that the page layout is corrected, as shown in FIG. 12D and FIGS. 13A to 13C (see pages 800d to 800g). On page 800g shown in FIG. 13C, all the distances 1 to 7 are unified to the same small value (=5); however, it may be appropriate to stop the unification of the distances at the state shown in FIG. 13B in consideration of the initial layout plan.

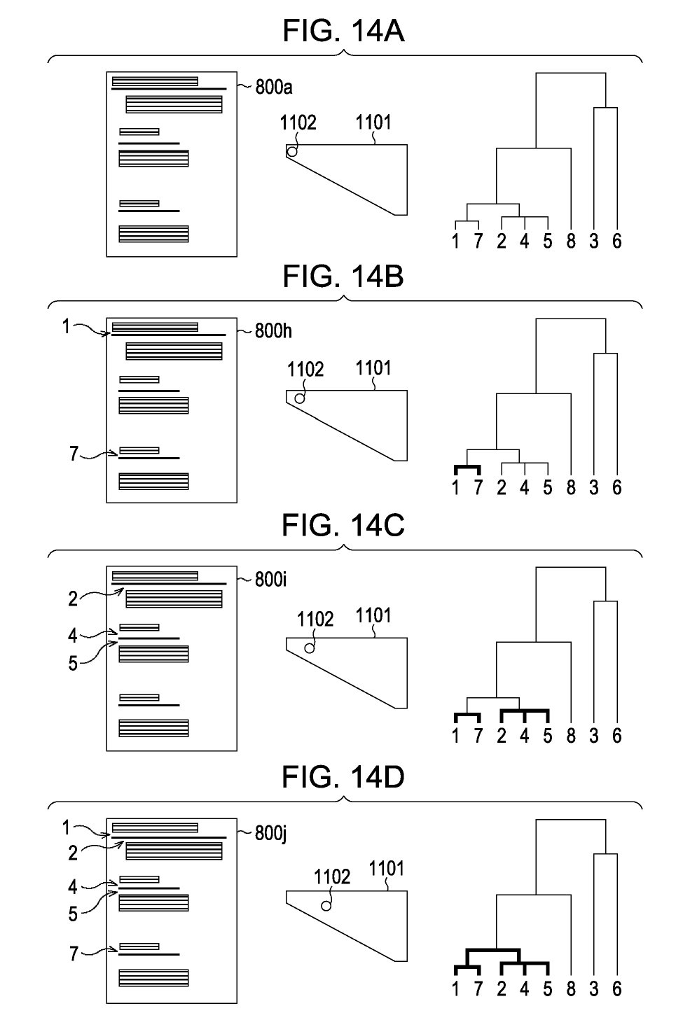

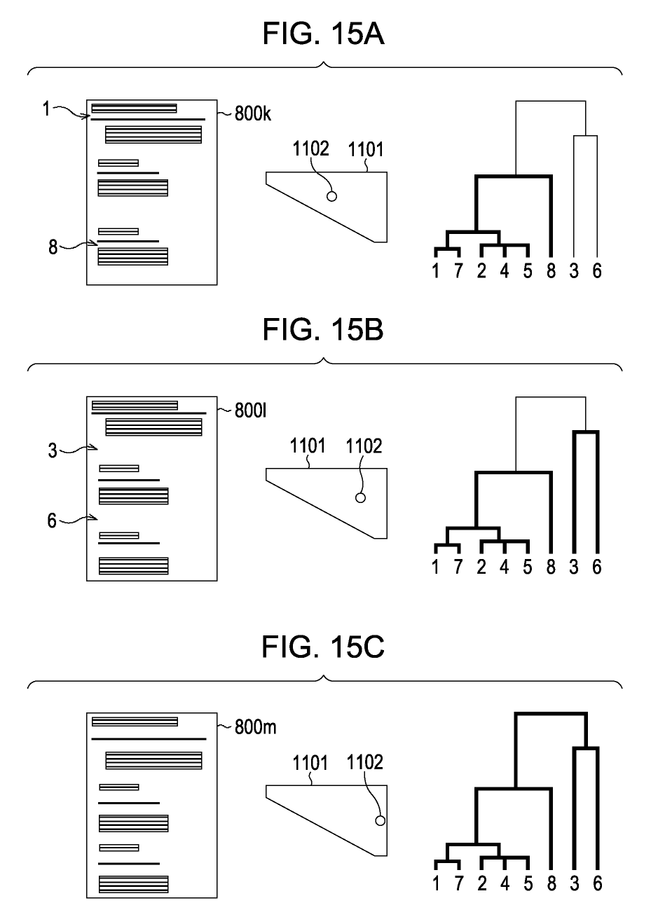

FIGS. 14A to 14D and FIGS. 15A to 15C are diagrams showing a state in which the page layout in FIG. 8 is changed by a vertical operation to the center and a lateral (horizontal) operation on the distance-adjustment graphical user interface 1100 and an example of pairs of distances that are unified at the individual operation states. FIGS. 14A to 14D and FIGS. 15A to 15C also show unified distance pairs with bold lines on the dendrogram. In FIGS. 14A to 14D and FIGS. 15A to 15C, the vertical position of the button 1102 is different from that in FIGS. 12A to 12D and FIGS. 13A to 13C.

As shown in FIGS. 14A to 14D and FIGS. 15A to 15C, the way of rising in the level of the dendrogram is the same as in FIGS. 12A to 12D and FIGS. 13A to 13C; however, the representative values obtained in the states of the individual diagrams are mean values of the distances in the individual clusters. Therefore, the page layouts shown in FIGS. 14A to 14D and FIGS. 15A to 15C are such that the distances between the objects are longer than those shown in FIGS. 12A to 12D and FIGS. 13A to 13C (see pages 800b to 800g in FIGS. 12B to 12D and FIGS. 13A to 13C and pages 800h to 800m in FIGS. 14B to 14D and FIGS. 15A to 15C).

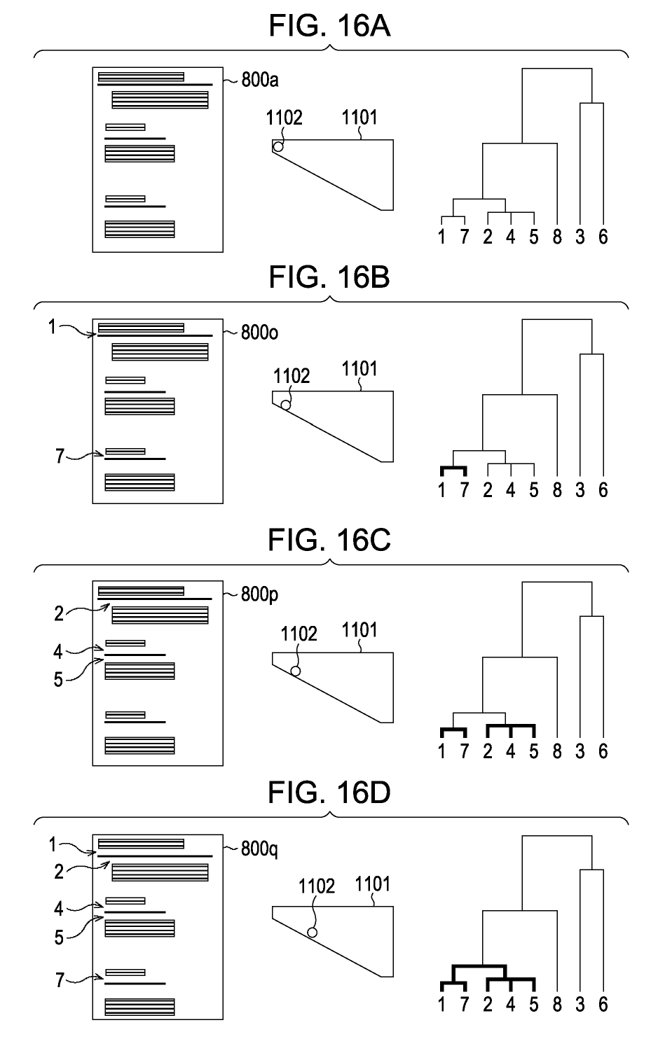

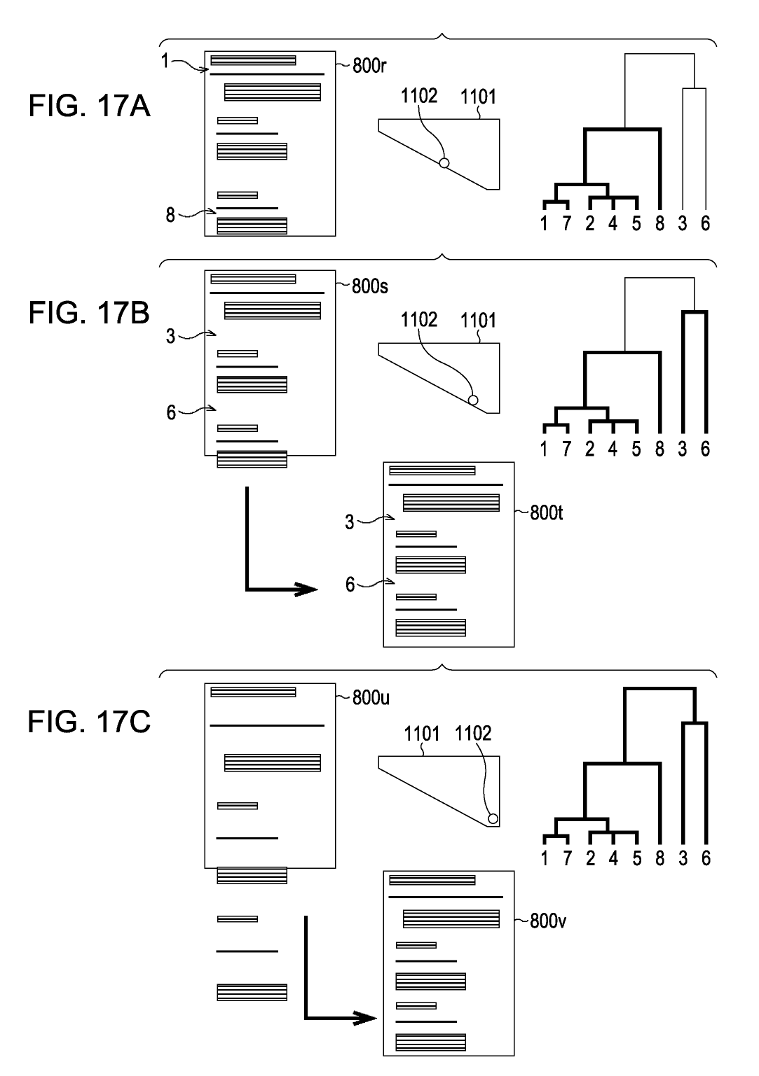

FIGS. 16A to 16D and FIGS. 17A to 17C are diagrams showing a state in which the page layout shown in FIG. 8 is changed by a vertical downward operation and a lateral (horizontal) operation on the distance-adjustment graphical user interface 1100 and an example of pairs of distances that are unified at the individual operation state. FIGS. 16A to 16D and FIGS. 17A to 17C also show unified distance pairs with bold lines on the dendrogram. In FIGS. 16A to 16D and FIGS. 17A to 17C, the vertical position of the button 1102 is different from that in FIGS. 14A to 14D and FIGS. 15A to 15C.

As shown in FIGS. 16A to 16D and FIGS. 17A to 17C, the way of rising in the level of the dendrogram is the same as in FIGS. 12A to 12D and FIGS. 13A to 13C and FIGS. 14A to 14D and FIGS. 15A to 15C; however, the representative values obtained in the states of the individual diagrams are the largest of the distances in the individual clusters. Therefore, the page layouts shown in FIGS. 16A to 16D and FIGS. 17A to 17C are such that the distances between the objects are longer than those shown in FIGS. 14A to 14D and FIGS. 15A to 15C (see pages 800h to 800m in FIGS. 14B to 14D and FIGS. 15A to 15C and pages 800o to 800s and 800u in FIGS. 16B to 16D and FIGS. 17A to 17C).

As a result, in the state shown in FIGS. 17B and 17C, the distances increase, so that the objects exceed the area of the page. To solve this problem, this embodiment performs the following process: the layout processing section changes (for example, rounds down) a representative value that causes the objects to exceed the page to a value so that the objects in the page fall within one page.

Specifically, in the case where an object protrudes from the page 800s, as in page 800s shown in FIG. 17B, the representative values of the distances between the objects are changed so that all the objects fall within page 800t, as shown in the page 800t. Also in the case where objects protrude, as in page 800u shown in FIG. 17C, the representative values of the distances between the objects are changed so that all the objects fall within page 800v, as shown in the page 800v.

For example, there is the following method for changing the representative values of the distances between objects; that is, a value (margin) that is obtained by subtracting the vertical size (height) of all the objects in a target page from the height of the page is divided proportionally in accordance with the ratio of the distances between the objects in their protruding state.

As described above, the distance-adjustment graphical user interface 1100 of this embodiment is configured such that “to what extent the distances are to be unified” and “to which value close distances should be unified” can be set at the same time.

In addition, in this embodiment, the states of the pages 800a to 800v shown in FIGS. 12A to 17C are displayed one by one on a display 144 in accordance with the operation on the distance-adjustment graphical user interface 1100 (button 1102).

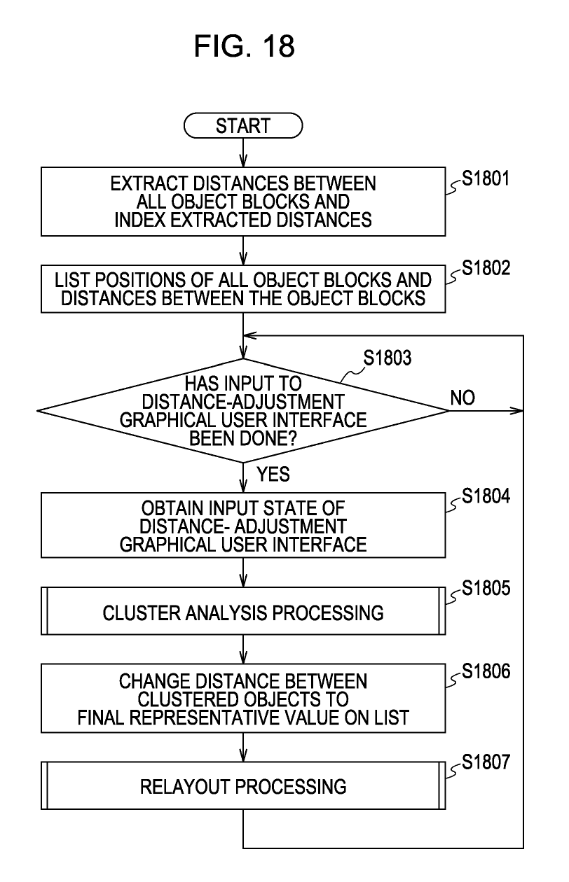

Next, referring to flowcharts in FIGS. 18 to 20, an example of the process of the document-layout editing apparatus when changing page layout by changing the distances between objects will be described. In this embodiment, a layout processing section, a cluster-analysis processing section, and a relayout processing section can be achieved using the processor unit (CPU) 135, the memory unit 136, the CD-ROM drive 142, the HDD 140, etc. The procedures (programs) shown in the flowcharts in FIGS. 18 to 20 are stored in either of the memory unit (RAM or ROM) 136 and the HDD 140 and are executed by the processor unit (CPU) 135.

The layout processing section performs the process of adjusting the positions of objects arranged on the page layout of a document to be edited, with reference to the document. When the layout processing section detects a specified operation by a user, the process first moves to step S1801 in FIG. 18.

In step S1801, the layout processing section performs the process of extracting the distances between all the object blocks in accordance with the definition of the distance between the objects, as shown in FIG. 6, and indexing the object blocks. Assume that the object blocks here are grouped into blocks by the flowchart shown in FIG. 5. Therefore, even a simple description “object” can be described as “object block”. On the other hand, a description “object block” can be simply described as “object”. Thus, in this embodiment, an example of an extracting unit can be achieved by, for example, the process of step S1801.

Next, in step S1802, the layout processing section makes a list LB of information on the distances extracted in step S1801.

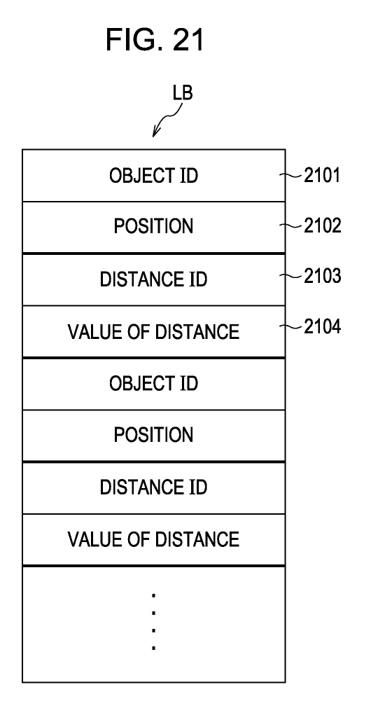

FIG. 21 is a diagram showing an example of the structure of the list LB in which information on object blocks and distances.

In FIG. 21, the list LB stores an object ID 2101 and an object position 2102 identified by the object ID 2101. Furthermore, the list LB stores a distance ID 2103 for identifying the distance between the object identified by the object ID 2101 and an object following the object, and the value 2104 of the distance identified by the distance ID 2103. These information is continuously stored in the list LB.

Referring back to FIG. 18, in step S1803, the operating system in which the layout processing section is operating stands by until a user input operation is made to the distance-adjustment graphical user interface 1100 shown in FIG. 11. When a user input operation is performed on the distance-adjustment graphical user interface 1100, the operating system passes information indicating the description of the user input operation to the layout processing section.

In step S1804, the layout processing section obtains the input state of the distance-adjustment graphical user interface 1100 from the operating system.

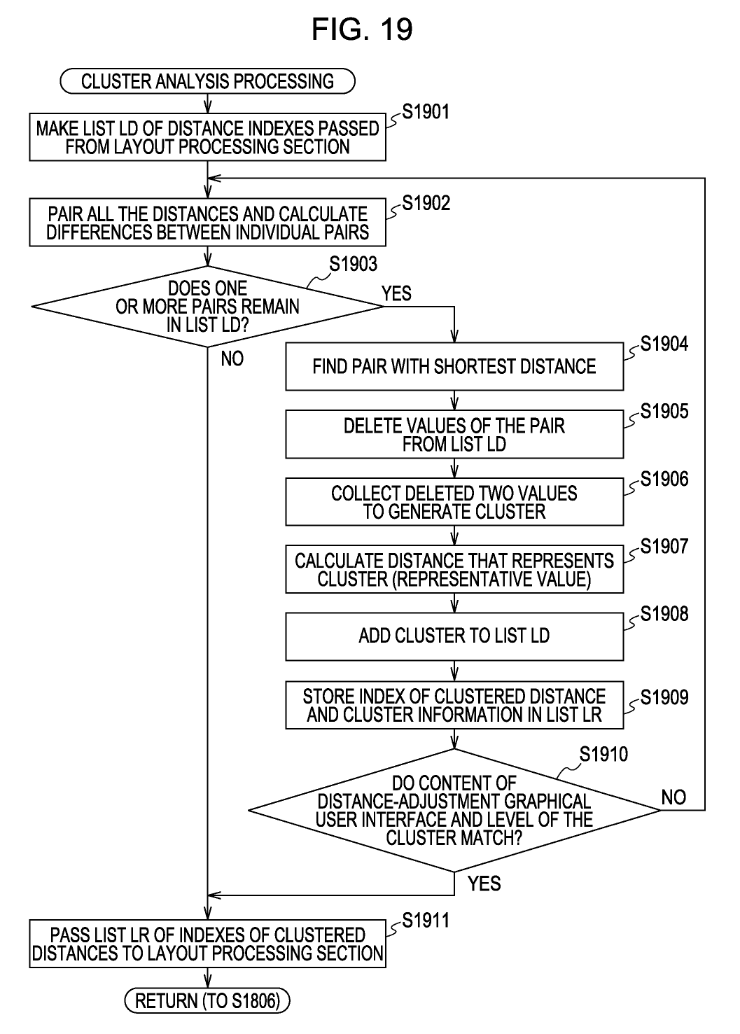

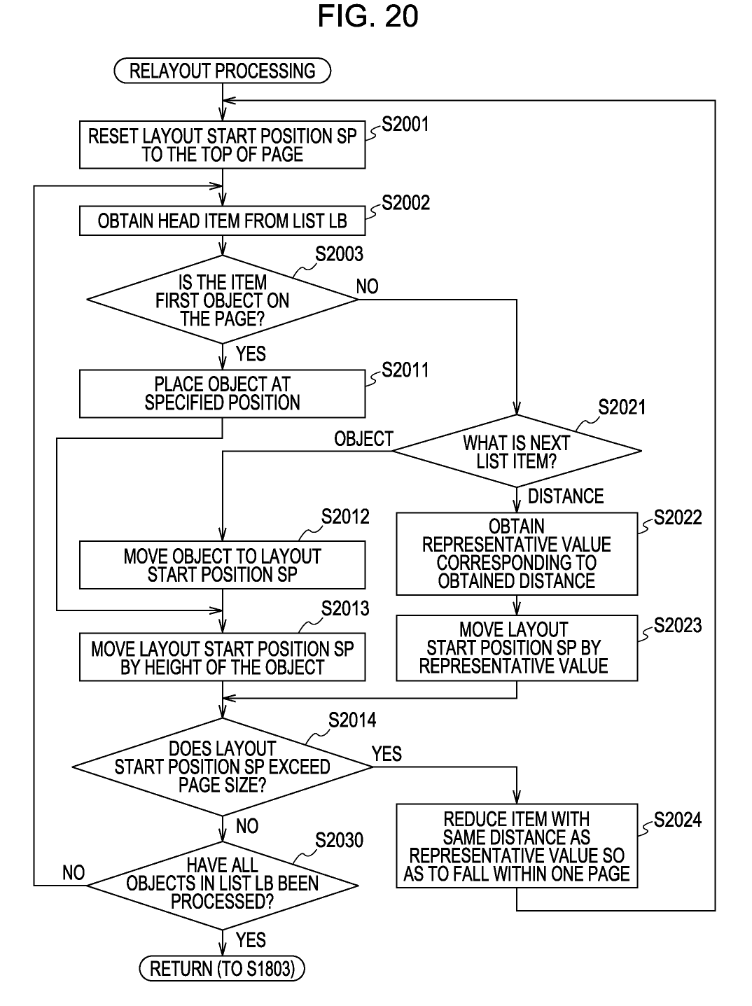

Next, in step S1805, the layout processing section passes the information indicating the input state of the distance-adjustment graphical user interface 1100 and the information on the list LB, obtained in step S1802, to the cluster-analysis processing section. The cluster-analysis processing section executes cluster analysis processing on the basis of these information. The details of the process in step S1805 will be described below with reference to FIG. 19.

After completion of the cluster analysis processing, the layout processing section performs the following process in step S1806. That is, the layout processing section obtains the result of execution of the cluster analysis processing from the cluster-analysis processing section and changes the “the value of the distance between the objects, 2104” on the list LB shown in FIG. 21 to the final representative value on the basis of the obtained information.

Next, in step S1807, the relayout processing section receives the information on the list LB and the information on the result of execution of the cluster analysis processing from the layout processing section and executes relayout processing of rearranging the object blocks on the page on the basis of the received information. The details of the process in step S1807 will be described later with reference to FIG. 20.

FIG. 19 is a flowchart that describes in detail an example of the cluster analysis processing in step S1805 of FIG. 18.

The cluster analysis processing is processing for analyzing the positions of the objects based on the present page layout and adjusting the values of the distances between the objects depending on the state of the distance-adjustment graphical user interface 1100. When execution of the cluster analysis processing is started in the cluster-analysis processing section, the process first moves to step S1901 in FIG. 19.

In step S1901, the cluster-analysis processing section extracts only the elements of the distances between the objects (for example, the distance ID 2103 and the value of the distance, 2104) from the information on the list LB and registers them on a list LD.

Next, in step S1902, the cluster-analysis processing section pairs the values of all the distances on the basis of the list LD and calculates the difference between the values of each pair.

Next, in step 1903, the cluster-analysis processing section determines whether one or more pairs of the values of the distances remain on the list LD.

If it is determined that one or more pairs of the values of distances do not remain in the list LD, the process moves to step S1911, described above. On the other hand, if one or more pairs of the values of distances remain on the list LD, the process moves to step S1904. In step S1904, the cluster-analysis processing section finds, “a distance pair” with the smallest difference from the list LD. Next, in step S1905, the cluster-analysis processing section deletes the values of the pair, found in step S1904, from the list LD.

Next, in step S1906, the cluster-analysis processing section collects the two values of the distances, which are deleted from the list LD in step S1905, to generate a cluster.

Thus, in this embodiment, an example of a collecting unit can be achieved by executing the process of step S1906.

Next, in step S1907, the cluster-analysis processing section refers to the vertical position of the button 1102, of the input state of the distance-adjustment graphical user interface 1100, passed from the layout processing section. The cluster-analysis processing section calculates and determines the value of the distance (representative value) that represents the cluster generated in step S1906.

Next, in step S1908, the cluster-analysis processing section adds the cluster generated in step S1906 as an element of a new distance between objects in the list LD.

Next, in step S1909, the cluster-analysis processing section stores the index of the clustered distance and information on the cluster in a list LR.

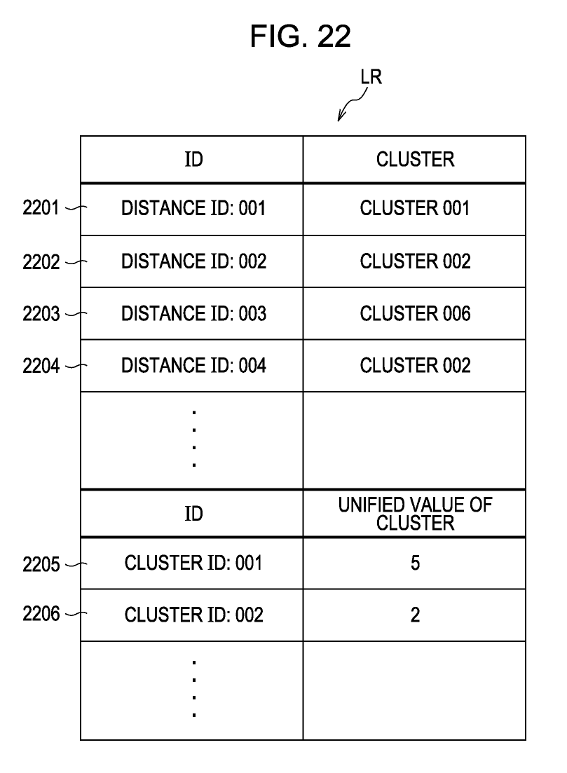

FIG. 22 is a diagram showing an example of the structure of the list LR in which information on clusters is collected.

In FIG. 22, distance IDs 2201 to 2204 etc. that identify the distances between clustered objects are listed in association with information for identifying the clusters. Cluster IDs 2205, 2206, etc. that identify clusters corresponding to the distance IDs 2201 to 2204 are listed in association with the representative values (unified values) of the clusters.

Referring back to the description in FIG. 19, in step S1910, the cluster-analysis processing section refers to the lateral (horizontal) position of the button 1102, of the input state of the distance-adjustment graphical user interface 1100, passed from the layout processing section. Then, the cluster-analysis processing section determines whether the level of the calculated cluster and the input state of the distance-adjustment graphical user interface 1100 match.

If it is determined that the level of the calculated cluster and the input state of the distance-adjustment graphical user interface 1100 do not match, the process returns to step S1902 described above. The clustering process is repeated also for the list LD to which clusters are added as the element of distance.

On the other hand, if the level of the calculated cluster and the input state of the distance-adjustment graphical user interface 1100 match, the process moves to step S1911. In step S1911, the cluster-analysis processing section passes, for example, the indexes of the clustered distances and information of the list LR indicating which value the values of the distances are to be unified to, as information of the result of cluster analysis processing, to the layout processing section. The process then moves to step S1806 in FIG. 18, described above.

Thus, in this embodiment, an example of a unifying unit can be achieved by executing the processes of step S1907, S1909 to S1911, and step S1806 in FIG. 18, described above.

FIG. 20 is a flowchart that describes in detail an example of the relayout processing in step S1807 of FIG. 18.

The relayout processing is processing for adjusting the distances between objects on a page layout on the basis of the result of unification of the distances between the objects, obtained by the cluster analysis processing. When the relayout processing is started by the relayout processing section, the process first moves to step S2001 in FIG. 20. When the process moves to step S2001, the relayout processing section inputs the information of the lists LB and LR, described above, from the layout processing section, etc.

In step S2001, the relayout processing section resets a layout start position SP for storing a layout start position at the top of the page.

Next, in step S2002, the relayout processing section obtains information on the head item of unselected objects from the list LB.

Next, in step S2003, the relayout processing section determines whether the item obtained in step S2002 is the first object on the page. If it is determined that the object obtained in step S2002 is not the first object on the page, the process moves to step S2021 described below.

On the other hand, if the item obtained in step S2002 is the first object on the page, the process moves to step S2011. In step S2011, the relayout processing section places the object obtained in step S2002 at a specified position.

Next, in step S2013, the relayout processing section moves the layout start position SP, for example, downward, by the height of the object obtained in step S2002.

Next, in step S2014, the relayout processing section determines whether the moved layout start position SP exceeds the page size. If it is determined that the moved layout start position SP exceeds the page size, the process moves to step S2024 described below. On the other hand, if the moved layout start position SP does not exceed the page size, the process moves to step S2030. In step S2030, the relayout processing section determines whether all of the objects on the list LB have been processed. If it is determined that all of the objects on the list LB have not been processed, the process moves to step S2002, described below, in which the next item registered in the list LB is processed.

On the other hand, if all of the objects on the list LB have been processed, the process returns to step S1803 in FIG. 18.

In step S2003, it is determined that the item obtained in step S2002 is not the first object on the page, the process moves to step S2021. In step S2021, it is determined which of an object and a distance the item obtained from the list LB is. If it is determined that the item obtained from the list LB is a distance, the process moves to step S2022 described below.

On the other hand, if the item obtained from the list LB is an object, the process moves to step S2012. In step S2012, the relayout processing section moves the obtained object to the object-layout start position SP. The process moves to the step S2013 described above, in which the layout start position SP is moved by a length corresponding to the height of the obtained object.

In step S2021, if it is determined that the item obtained from the list LB is a distance, the process moves to step S2022. In step S2022, the relayout processing section obtains a representative value corresponding to the distance obtained from the list LB from the list LR passed from the layout processing section. That is, the relayout processing section determines, from the list LR, to what representative value the value of the distance obtained from the list LB is changed (of course, the value of the distance is sometimes not changed).

Next, in step S2023, the relayout processing section moves the layout start position SP, for example, downward, by a length corresponding to the representative value obtained in step S2022. The process moves to step S2014 described above, in which it is determined whether the moved layout start position SP exceeds the page size.

Thus, in this embodiment, an example of a changing unit can be achieved by executing the processes of step S2023, for example.

In step S2014, if it is determined that the layout start position SP exceeds the page size, the process moves to step S2024. In step S2024, the relayout processing section obtains an item with the same distance as the representative value of the distance obtained in step S2022 while going back the page and reduces the representative value so that all the obtained objects fall within one page. Then, the process is started again from step S2001 described above.

Thus, in this embodiment, an example of a correcting unit can be achieved by executing the processes of step S2024, for example.

As described above, in this embodiment, distances between adjacent objects in the document are extracted; next, the extracted plurality of distances are collected on the basis of a lateral (horizontal) position on the distance-adjustment graphical user interface 1100; the plurality of distances are unified to representative values based on a vertical position on the distance-adjustment graphical user interface 1100; next, the objects are rearranged (laid out again) so that the distances between the adjacent objects in the document become the representative values.

This allows the distances between irregular objects on one page to be accurately unified as distance rules for the document as soon as possible by simple operation in consideration of user's intension, not simply making all the distances equal.

Thus, in editing objects using, for example, a drawing application, this can provide usage, such as roughly placing objects and thereafter adjusting the distances therebetween for shaping, which makes a page layout operation easier than relate art. This also allows users who are not skilled in page layout to easily form unification rules for the distances between the objects in a document, thereby easily improving the appearance of the entire document.

For an application for converting existing documents, such as a PDF-editing application, rules for the distances between the objects in a document in which a plurality of existing documents are merged can be unified in the merged document in consideration of the rules for the original documents. This can easily improve the appearance of the entire document.

Furthermore, the result of operation for the distance-adjustment graphical user interface 1100 can be reflected to the page layout one after another so that the user can view it. This allows the user to perform input operation to the distance-adjustment graphical user interface 1100 while viewing a state in which the spaces between the objects to be unified step by step from a narrow area to a wide area. This allows even an unskilled user to view desired layout.

Furthermore, in this embodiment, if objects protrude from the page as a result of rearrangement (relayout) by unifying the plurality of distances of adjacent objects to representative values, the representative values can be corrected. This can prevent a failure in page layout more reliably.

### Second Embodiment

Next, a second embodiment of the present invention will be described. Although the first embodiment has been described using the method of adjusting the page layout in one page by way of example, this embodiment will be described using a method of changing the page layout of the entire document. The difference between this embodiment and the first embodiment is part of the contents in the list LB and part of the relayout processing. Accordingly, in this embodiment, detailed descriptions of the same parts as in the first embodiment will be omitted by giving the same reference numerals as in FIGS. 1 to 22.

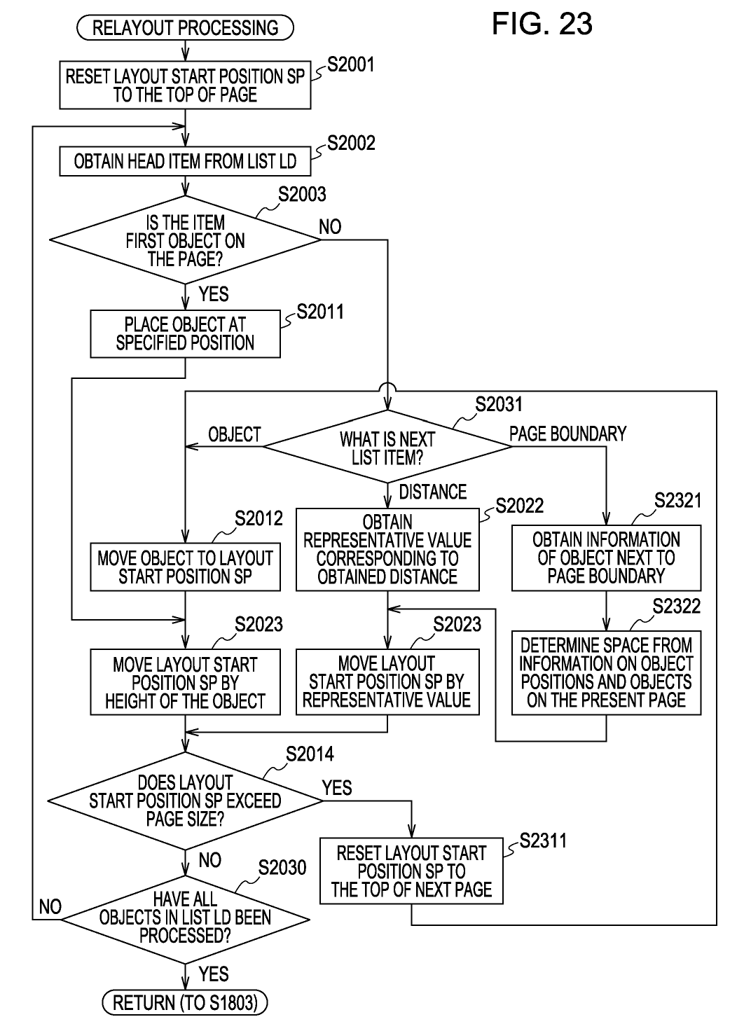

FIG. 23 is a flowchart describing in detail an example of the relayout processing in step S1807 of FIG. 18. Differences from the relayout processing in the first embodiment shown in FIG. 20 is only steps S2301, S2311, S2321, and S2322 and the others are the same as in FIG. 20. Therefore, only the difference from FIG. 20 will be described here.

An object of this embodiment is to rearrange an object block across a page boundary.

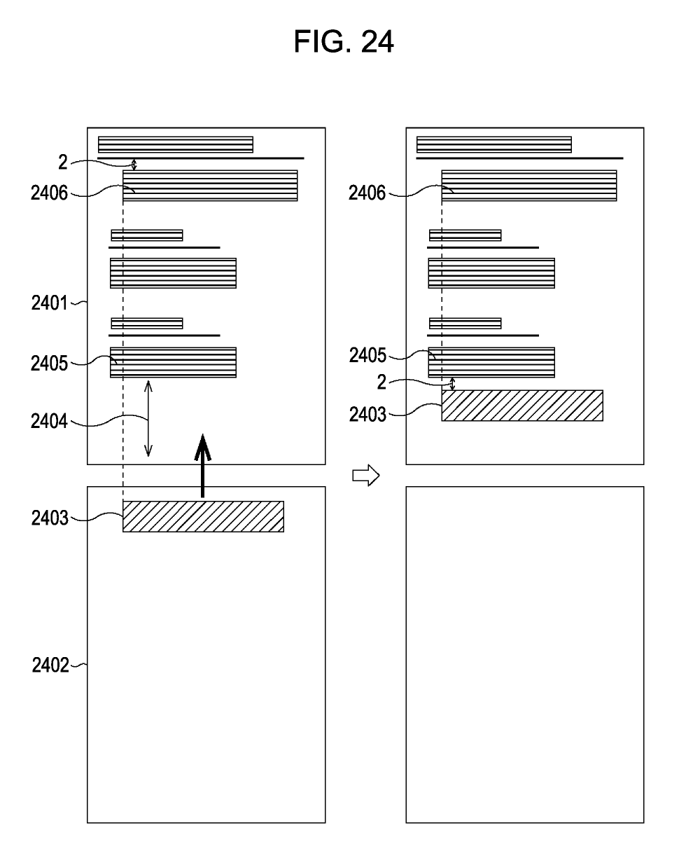

FIG. 24 is a conceptual diagram showing an example of a state in which an object block is rearranged across the page boundary.

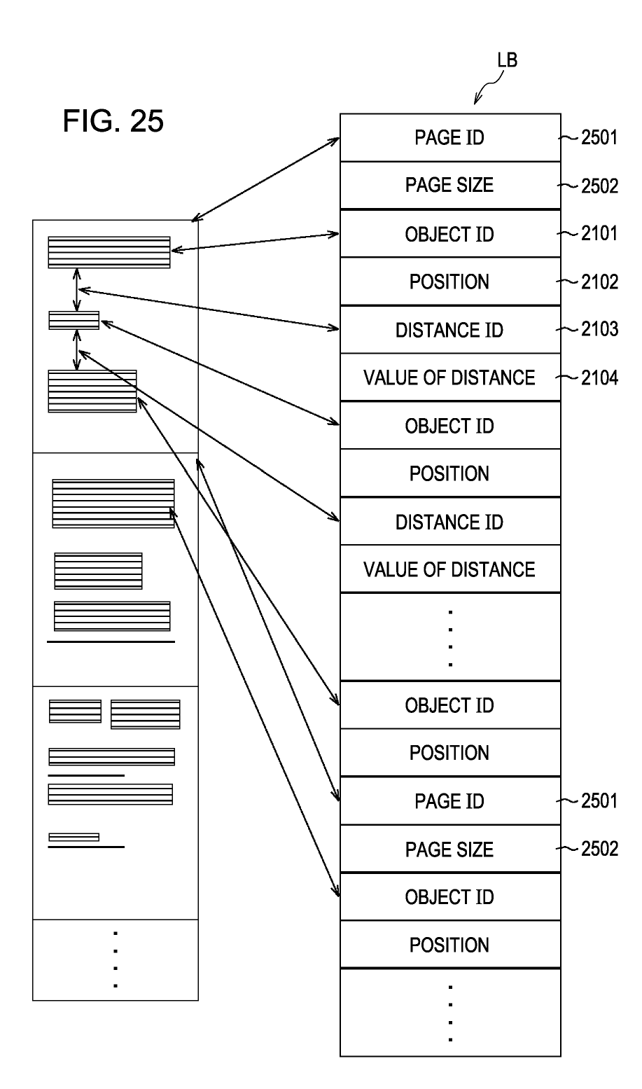

FIG. 24 shows that there are a page 2401 and a page 2402, in which an object block 2403 is moved and rearranged from the page 2402 to the page 2401. When the distances between the object blocks are reduced by adjusting the distances between the objects on the page 2401 to generate a margin 2404 at the lower part of the page 2401, the page 2402 can be made unnecessary by removing the object block 2403 from the page 2402. This allows an unnecessary page to be deleted from the document, thus providing an effective method for “economic printing” for reducing the number of print pages. As described above, the relayout processing is for adjusting the distances between the actual objects on a page layout on the basis of the result of unification of the distances between the objects obtained by the cluster analysis processing. When the relayout processing is started in the relayout processing section, the process first moves to step S2001 in FIG. 23. When the process moves to step S2001, the relayout processing section inputs the information on the lists LB and LR from the layout processing section etc. The list LB in this embodiment lists the information of the objects on all the pages of a target relayout document. FIG. 25 is a diagram showing an example of the structure of the list LB in which information on the object blocks and the distances of all the pages of the document is listed.

The list LB in FIG. 25 is the same as the list LB shown in FIG. 21 in that the object ID 2101, the position 2102, the distance ID 2103, and the value of the distance, 2104 are included. However, the list LB of this embodiment also includes a page ID 2501 and its page size 2502, as information for delimiting the objects of each page, which is different from the list LB in FIG. 21. FIG. 25 shows the correspondence between the individual data elements in the list LB and the actual objects on the pages with arrows. Here, a contiguous long region in which all the pages of the document are joined is assumed, and then the relayout processing is executed.

An example of a method for relayout processing will be described hereinbelow using an example in which page boundary information (page ID 2501, page size 2502) shown in FIG. 25 is used.

If it is determined in step S2003 in FIG. 23 that the item obtained in step S2002 is not the first item on the page, the process moves to step S2301, in which the relayout processing section determines which of an object, a distance, and a page boundary the item obtained from the list LB is.

If it is determined that the item obtained from the list LB is a page boundary, the process moves to step S2321. In step S2321, the relayout processing section obtains information on the object next to the page boundary from the list LB.

Next, in step S2322, the relayout processing section executes the following processing. That is, the relayout processing section calculates a distance to be provided on the page for which page layout (relayout) is performed, on the basis of information on the position of the object obtained in step S2321 and the objects included in the page.

An example of the processing in step S2322 will be described with reference to FIG. 24.

As shown in FIG. 24, in the case where an object block 2403 on the next page is rearranged in the margin at the lower part of the page 2401, it is necessary to determine the distance between the object block 2403 and an object block 2405. The object block 2403 and the object block 2405 originally belong to different pages. This poses a problem of how to provide the margin between the object blocks which are not originally next to each other.

Thus, in this embodiment, for example, for the page 2401, the left end position of the object block 2406 and the left end position of the object block 2403 are close to each other; therefore, it is regarded that there is similarity between the object blocks 2403 and 2406. The relayout processing section sets the distance 2 between the object block 2406 and an object block above it as the distance between the object block 2403 and the object block 2405 with reference to the distance 2. This is an example of the processing in step S2322. Here, although only the left end positions of the object blocks are referred to, the invention is not limited thereto. For example, in addition to or instead of the left end positions of the object blocks, the similarity of the other elements of the object blocks (right end positions, widths, lengths, densities of images, etc.) may be used. This also allows the object block 2403 on the next page to be rearranged, for example, in the margin at the lower part of the page 2401, as in the above.

Thus, in this embodiment, an example of a determining unit can be achieved by executing the process of step S2322, for example.

Referring back to FIG. 23, after the distance has been determined, in step S2023, the relayout processing section moves the layout start position SP, for example, downward, on the basis of the distance obtained in step S2322.

Thus, in this embodiment, in addition to the changing unit, an example of a second changing unit can also be achieved by executing the process of step S2322, for example.

In step S2014, it is determined that the moved layout start position SP exceeds the page size, the process moves to step S2311. In step S2311, the relayout processing section resets the value of the layout start position SP to the top of the next page. The process moves to step S2012, in which the obtained object is moved to the object layout start position SP.

In this way, even if the list LB has information on the objects and the distance therebetween of all the page of the document, page layout can be performed as in the first embodiment. Thus, in addition to the advantages of the first embodiment, this embodiment can rearrange objects across the page boundary, thus accelerating effective use of the page regions of a document. Furthermore, the distance between the object blocks 2403 and 2405 is determined on the basis of the attributes (similarity etc.) of the object block 2403 to be changed in page and the object blocks on the page 2401 to which the object block 2403 is moved. Thus, a layout having little noticeable difference can be provided by obtaining an optimum distance as the distance between the objects that straddle the page boundary.

### Third Embodiment

Next, a third embodiment of the present invention will be described. The first and second embodiments have been described using the example in which the processes are performed using dedicated application software. In contrast, this embodiment will be described using an example in which the processes are performed by a printer driver. The difference between this embodiment and the first and second embodiments described above is the subject of processing. Accordingly, in this embodiment, detailed descriptions of the same part as in the first and second embodiments will be omitted by giving the same reference numerals as in FIGS. 1 to 25.

The system of this embodiment is also equipped with the computer module 101 serving as a host computer and the local printer 145 connected thereto, as in the first and second embodiments (see FIG. 1). The computer module 101 has a printer driver for generating print job data including a drawing instruction to the local printer 145.

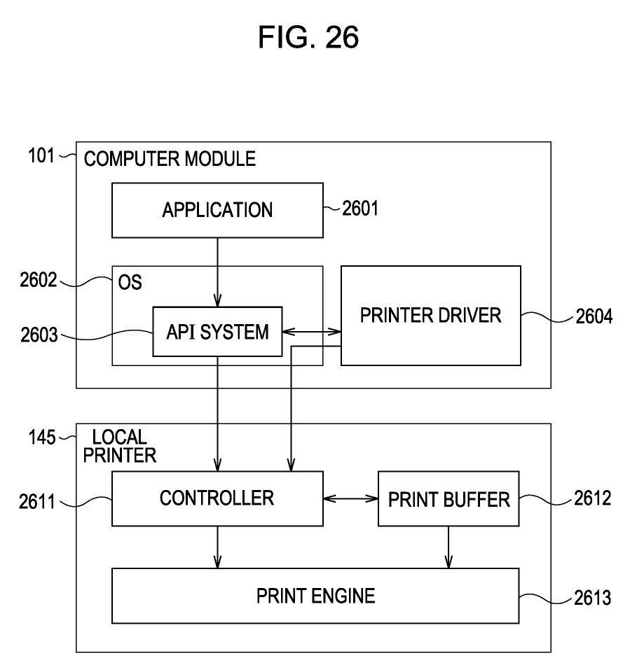

FIG. 26 is a diagram showing an example of the functional configuration of the computer module 101 and the local printer 145.

In the computer module 101, an operating system (OS) 2602 operates, so that an application 2601 and a printer driver 2604 are operated on the OS 2602. The application 2601 and the printer driver 2604 perform print processing in cooperation with each other using or through an application program interface (API) system 2603 in the OS 2602. The API SYSTEM 2603 includes a graphic device interface (GDI) etc.

Print job data generated in the printer driver 2604 through the OS 2602 and the API system 2603 is sent to a controller 2611 in the local printer 145. The controller 2611 expands data based on a drawing instruction included in the print job data into a print buffer 2612. A print engine 2613 performs drawing processing using the data expanded in the print buffer 2612.

Here, the printer driver 2604 includes, in the drawing instruction, at least information for identifying the individual objects and position information, such as coordinates, for determining the positions of the individual objects on the page. This allows also the printer driver 2604 to perform the same operations of the layout processing section etc., described in the first and second embodiments.

On the above premise, this embodiment can also offer the same advantages as in the first and second embodiments by achieving the processes of the flowcharts shown in FIGS. 18 to 20 by the printer driver 2604 and executing them by the CPU 135.

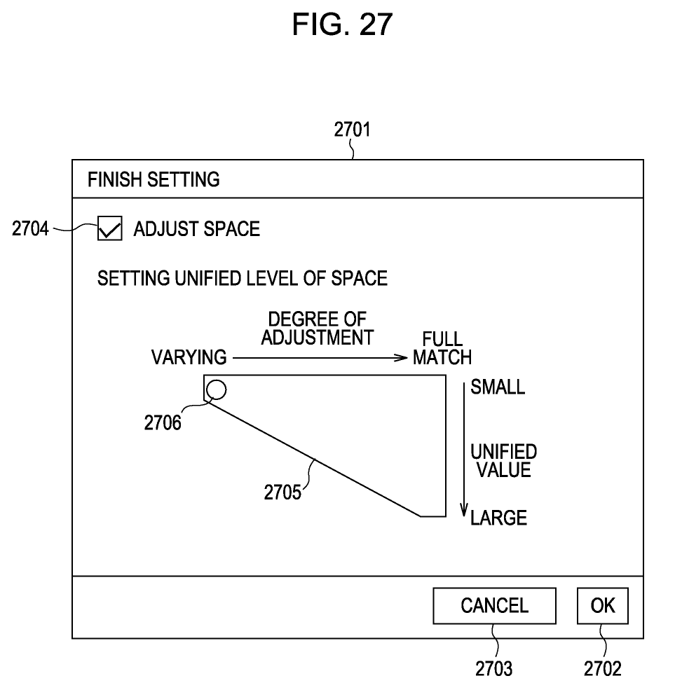

FIG. 27 is a diagram showing an example of a distance-adjustment graphical user interface. The distance-adjustment graphical user interface shown in FIG. 27 is for performing settings, in the printer driver 2604, similar to that of the distance-adjustment graphical user interface 1100 shown in FIG. 11.

A UI processing section can receive a user's operation for selecting whether to automatically adjust the distance between objects by the operation of a button control 2704 in a screen 2701. The printer driver 2604 can input a set value for automatically setting the distances between objects on the basis of a user's operation on “a region 2705 and a button 2706” that provide the same operation as that of the distance-adjustment graphical user interface 1100 shown in FIG. 11. In the example shown in FIG. 27, when a button 2702 is pressed by the user, the set value is transmitted to the printer driver 2604 and is stored therein. When a cancel button 2703 shown in FIG. 27 is pressed, the settings in the screen 2701 are cancelled.

Here, a case in which automatic adjustment of the distances between objects is set in advance is shown by way of example. In printing, one user's adjustment entry can generally be output as one print job. Therefore, this case does not take it into consideration to control the distances while viewing the state of adjustment of the distances on the screen, as in the first and second embodiments. However, for example, a printer driver that has a print-description preview function can also successively display a state in which the distances between objects are adjusted so that the user can adjust them while viewing it, as in the first and second embodiments.

Thus, in this embodiment, an example of the operating unit can be achieved using, for example, the screen 2701 shown in FIG. 27.

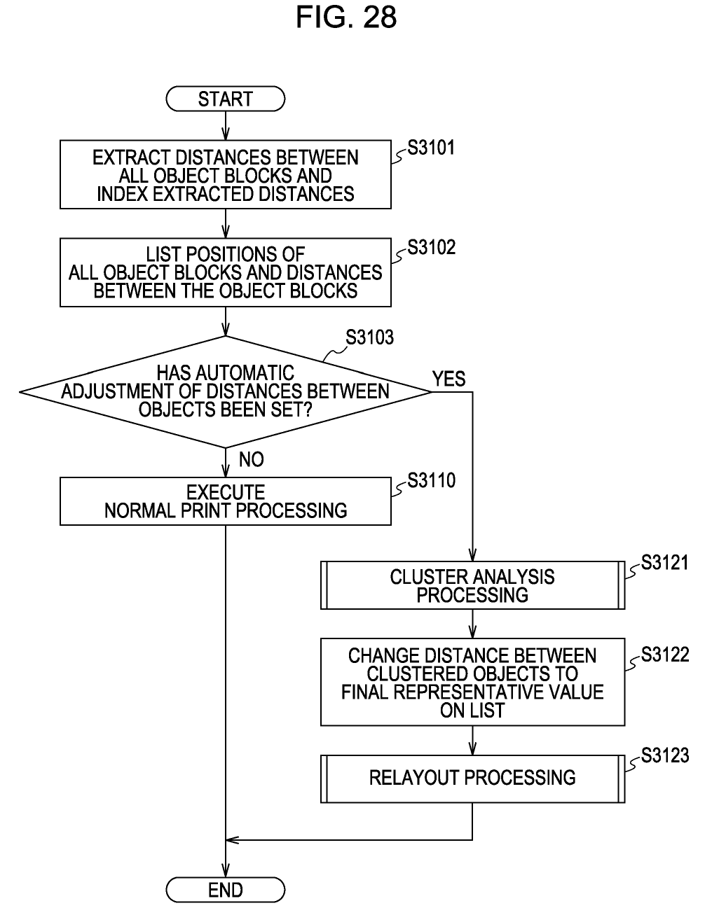

FIG. 28 is a flowchart describing an example of the process of the printer driver 2604 in the document-layout editing apparatus when changing a page layout by changing the distances between objects.

The printer driver 2604 adjusts the positions of objects arranged on the page layout of a document to be printed at the present with reference to the document. When the printer driver 2604 detects a user's specified operation, the process first moves to step S3101.

In step S3101, the printer driver 2604 extracts the distances between all the object blocks and indexes the object blocks.

In this embodiment, as described above, an example of the extracting unit can be achieved by performing, for example, the process in step S3101.

Next, in step S3102, the printer driver 2604 collects the information extracted in step S3101 in the list LB. The data structure of the list LB used here is the same as that used in the first or second embodiment.

Next, in step S3103, the printer driver 2604 obtains the description of user's input operation to the distance-adjustment graphical user interface shown in FIG. 27 and determines whether automatic adjustment of the distances between objects has been set. If it is determined that the automatic adjustment of the distances between objects has not been set, the process moves to step S3110, in which the printer driver 2604 performs normal print processing, and terminates the processing by the flowchart in FIG. 28.

On the other hand, if the automatic adjustment of the distances between objects has been set, the process moves to step S3121. In step S3121, the printer driver 2604 executes cluster analysis processing on the basis of information indicating the input state of the distance-adjustment graphical user interface and the information in the list LB, obtained in step S3102. Since the process in step S3121 is the same as that shown in FIG. 19, a description thereof will be omitted here. In this embodiment, as described above, an example of the collecting unit can be achieved by performing, for example, the process in step S1906 in FIG. 19.

After completion of the cluster analysis processing, in step S3122, the printer driver 2604 changes the values of the distances between objects on the basis of the result of cluster analysis processing.

In this embodiment, as described above, an example of the unifying unit can be achieved by performing, for example, the processes in step S1907 and steps S1909 to S1911 in FIG. 19 and the process in step S3122.

Next, in step S3123, the printer driver 2604 executes relayout processing for rearranging the object blocks on the page on the basis of the information in the list LB and information of the result of the cluster analysis processing. Since the process in step S3123 is the same as that shown in FIG. 20, a description thereof will be omitted here.

Thus, in this embodiment, an example of the changing unit and the second changing unit can be achieved by executing, for example, the process of step S2023 in FIG. 20; an example of the correcting unit is achieved by performing, for example, the process of step S2024 in FIG. 20; and an example of the determining unit is achieved by performing the process of step S2322 in FIG. 23.

In this way, this embodiment incorporates the layout adjustment system in the first and second printer drivers 2604. This allows printing operation to be performed without preparing special application software or replacing document data for the application software. Thus, in addition to the advantage of performing the automatic layout adjustment described in the first and second embodiments, the advantage of providing a more general-purpose function can be offered.

This embodiment is configured such that all the processes in FIG. 28 are performed by the printer driver 2604; however, the present invention is not limited thereto. For example, the process in step S3121 may be executed by the cluster-analysis processing section described in the first and second embodiments, and the process in step S3123 may be executed by the relayout processing section described in the first and second embodiments.

### Fourth Embodiment

Next, a fourth embodiment of the present invention will be described. The first to third embodiments have been described using the example in which the document-layout editing apparatus is applied to a host computer, such as a personal computer. In contrast, this embodiment will be described using an example in which the document-layout editing apparatus is applied to an image forming apparatus, such as an MFP, having multiple functions, such as a printer, a copying machine, and a facsimile machine. In this way, this embodiment and the first to third embodiments differ in a target device to which the document-layout editing apparatus is applied. Accordingly, in this embodiment, detailed descriptions of the same parts as in the first to third embodiments will be omitted by giving the same reference numerals as in FIGS. 1 to 28.

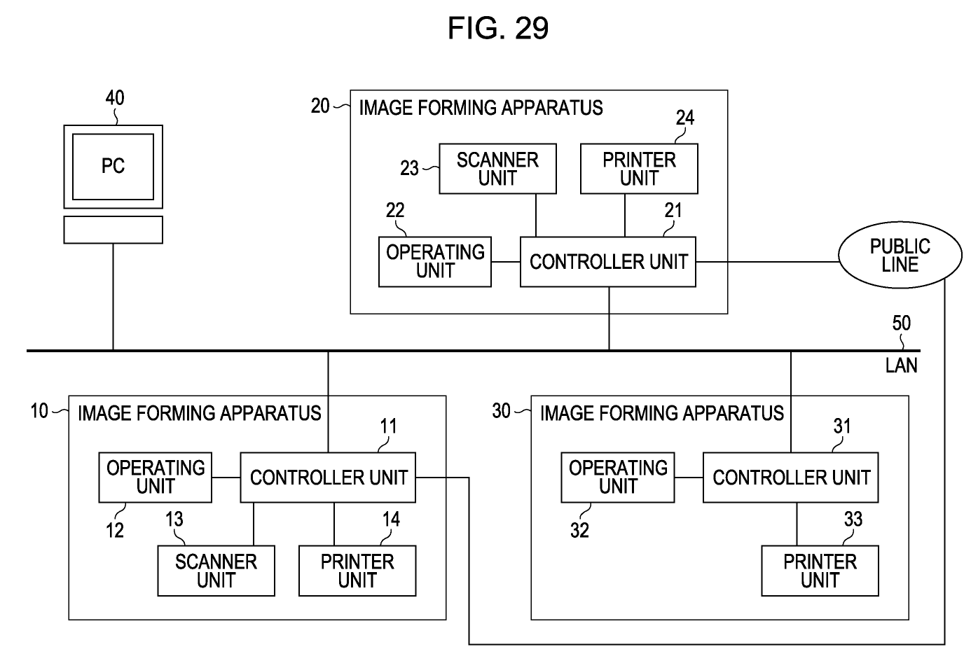

FIG. 29 is a diagram showing an example of a print system equipped with an image forming apparatus.

In the print system shown in FIG. 29, a host computer 40 and three image forming apparatuses 10, 20, and 30 are connected to a LAN 50. However, the number of host computers and image forming apparatuses connected in the print system is not limited thereto. The method for connecting the host computer and the image forming apparatuses is not limited to the LAN. For example, any network, such as WAN (public line), a serial transmission method, such as a USB, or a parallel transmission method, such as Centronics and SCSI, can be employed.

The image forming apparatuses 10 and 20 have the same configuration. The image forming apparatus 30 has only a print function and has not a scanner function that the image forming apparatuses 10 and 20 have. Thus, of the image forming apparatuses 10, 20, and 30, the configuration of the image forming apparatus 10 will be described in detail for the convenience of description.

The image forming apparatus 10 includes a scanner unit 13, which is an image input device, a printer unit 14, which is an image output device, a controller unit 11, which have control over the operation of the image forming apparatus 10, and an operating unit 12, which is a user interface.

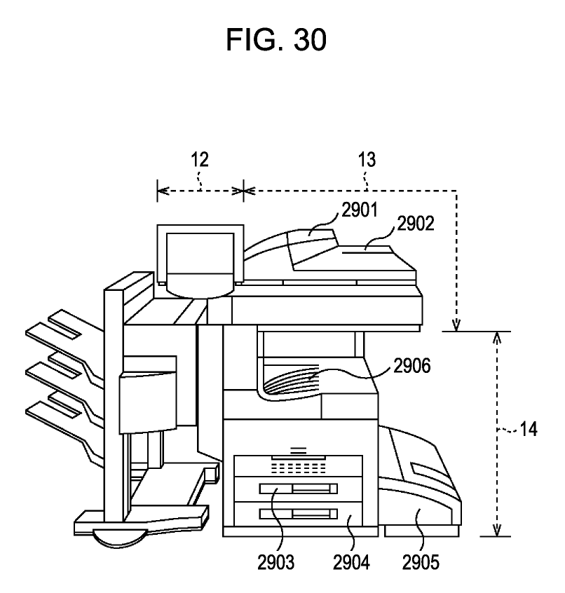

FIG. 30 is a diagram showing an example of the appearance configuration of the image forming apparatus 10.

The scanner unit 13 inputs reflected light obtained by scanning an image on an original with an exposure of light into a CCD to convert image information to an electric signal and outputs it to the controller unit 11 as image data.

The originals are placed on a tray 2902 of a document feeder 2901. When a user gives an instruction to start reading using the operating unit 12, the controller unit 11 gives an instruction to read the originals to the scanner unit 13. When receiving the instruction to read the originals, the scanner unit 13 feeds the originals one by one from the tray 2902 of the document feeder 2901 to read the originals.

The printer unit 14 is an image forming device that images image data received from the controller unit 11 onto sheets. The printer unit 14 is provided with a plurality of sheet cassettes 2903, 2904, and 2905 so that different sizes and orientations of sheets can be selected. Printed sheets are ejected onto a paper output tray 2906.

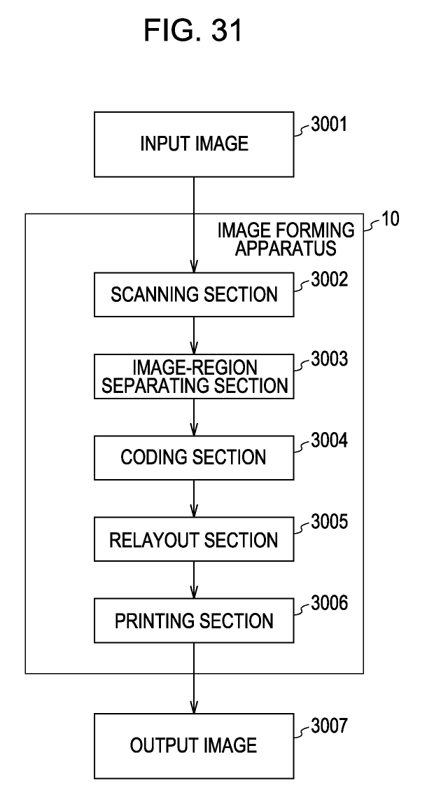

FIG. 31 is a diagram showing an example of the functional configuration of the image forming apparatus 10. In particular, the copying processing of the image forming apparatus 10 will be described using an example in which relayout is performed while the distances between objects are adjusted.

A scanning section 3002 scans an image 3001 input from the document feeder 2901 and images it. Thereafter, an image-region separating section 3003 separates the image region of the scanned image by a known technology into a plurality of blocks. A coding section 3004 converts the plurality of blocks to data of positions etc. A relayout section 3005 rearranges the objects by adjusting the distances therebetween on the basis of the data of the positions etc. A printing section 3006 prints the rearranged objects. An output image 3007 is output from the printer unit 14 in this way.

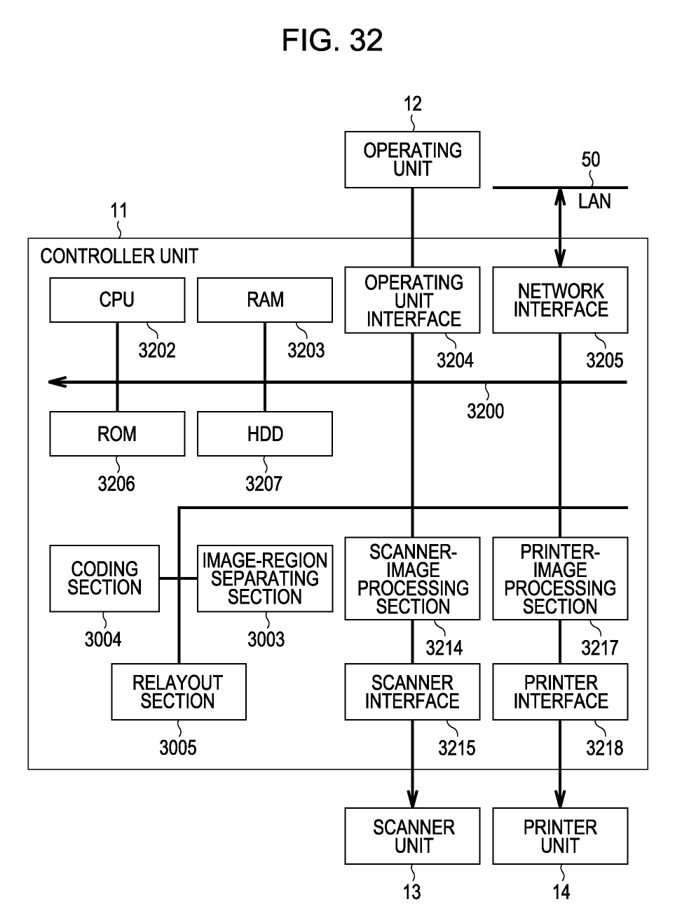

FIG. 32 is a diagram showing an example of the configuration of the controller unit 11 of the image forming apparatus 10 in more detail.

In FIG. 32, the controller unit 11 is electrically connected to the scanner unit 13 and the printer unit 14. As shown in FIG. 29, the controller unit 11 is mutually connected to the host computer 40, an external unit, etc. through the LAN 50. This allows the image forming apparatus 10 to input and output image data and device information.

A CPU 3202 controls over access to various devices that are mutually connected to the CPU 3202 through a system bus 3200 on the basis of control programs etc. stored in a ROM 3206. The CPU 3202 also controls over various processing performed in the controller unit 11. The ROM 3206 stores a boot program etc. for the image forming apparatus 10. A HDD 3207 is a hard disk drive capable of storing system software and image data.

An operating unit interface 3204 is an interface for mutually connecting a system bus 3200 and the operating unit 12. The operating unit 12 displays the screen 2701 shown in FIG. 27. The user can perform settings for layout adjustment (adjustment of the distances between objects) in the image forming apparatus 10 by operating the screen 2701 displayed on the operating unit 12.

A network interface 3205 connects to the LAN 50 and the system bus 3200 to input and output information.

A scanner-image processing section 3214 corrects, processes, and edits image data received from the scanner unit 13 through a scanner interface 3215. The scanner-image processing section 3214 determines whether the received image data is a color document, a monochrome document, a character document, a picture document, etc. The scanner-image processing section 3214 associates the result of determination with the image data. Such associate information is referred to as attribute data.

A printer-image processing section 3217 receives image data sent from the exterior and performs image processing on the received image data. The image data subjected to the image processing is output to the printer unit 14 through a printer interface 3218.

The image-region separating section 3003 separates the image region of the image that the scanner unit 13 received. The coding section 3004 converts the data in which the image region is separated to a data format that allows the relayout section 3005 to process.

The relayout section 3005 performs layout adjustment (adjustment of the distances between the objects) on the image forming apparatus 10 by executing the processing of the flowchart shown in FIG. 28 to do relayout of the image data in which the image region is separated. Since the processing of the flowchart shown in FIG. 28 is the same as that in the third embodiment, a detailed description thereof will be omitted.

In this embodiment, as described above, the relayout section 3005 achieves an example of the extracting unit, the changing unit, the correcting unit, the second changing unit, and the determining unit. An example of the operating unit is achieved by displaying the distance-adjustment graphical user interface as shown in FIGS. 11 and 27 on the operating unit 12 and receiving a user's operation.

In this way, this embodiment incorporates the layout adjustment system in the image forming apparatus. Thus, in addition the advantage of performing the automatic layout adjustment described in the first and second embodiments, the advantage of allowing the layout adjustment described in the first and second embodiments to be performed also for copied documents. This allows a good-appearance layout to be performed also for a paper document having no electronic data.

According to the embodiments of the present invention, the distances between adjacent objects on a document are extracted; the plurality of distances are unified to one or a plurality of representative values on the basis of the differences between the values of the distances; and the distances between the objects are adjusted on the basis of the representative values. This allows the user to adjust the differences between the objects without significantly breaking the original layout without the need for adjusting the distances between the objects by trial and error. Thus, the differences between the objects of a document can be adjusted more easily and appropriately than related art.

The purpose of the present invention can also be realized by executing the following process. That is, a process in which a recording medium, in which a program code of a software that realizes the functions of the above-described embodiments is recorded, is supplied to the system or apparatus, and then a computer of the system or apparatus (such as CPU or MPU) reads out the program code stored in the recording medium. In such a case, the program code read out from the recording medium itself realizes the functions of the above-described embodiments, and the recording medium where the program code is stored as well as the program code are included in the present invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-182046 filed Jul. 11, 2008, which is hereby incorporated by reference herein in its entirety.

1. A document-layout editing apparatus comprising:
an extracting unit configured to extract the distances between adjacent objects on a document;
a collecting unit configured to collect the plurality of distances into one or a plurality of groups on the basis of the difference between the plurality of distances extracted by the extracting unit;
a unifying unit configured to unify the distances collected by the collecting unit to a representative value; and
a changing unit configured to change the layout of the objects so that the distances between the adjacent objects on the document become the representative value corresponding to the distances.

2. The document-layout editing apparatus according to claim 1, further comprising:
an operating unit configured for a user to perform an operation for adjusting the distances between the adjacent objects on the document;
wherein the unifying unit selects a group corresponding to the result of the operation of the operating unit from the groups obtained by the collecting unit and unifies distances that belong to the selected group to a representative value based on the result of the operation of the operating unit.

3. The document-layout editing apparatus according to claim 1, further comprising:
a correcting unit configured, if it is determined that an object protrudes from a page on which the object is placed as a result of a change in the layout of the objects by the changing unit, to correct the representative value so that the object placed on the page falls within the page.

4. The document-layout editing apparatus according to claim 1, further comprising:
a determining unit configured, when a first object on a first page of the document is moved to a second page different from the first page, to determine the distance between the first object and a second object to be adjacent to the first object on the second page on the basis of the attribute of the first object and the attribute of the second object; and
a second changing unit configured to change the location of the first object on the basis of the distance determined by the determining unit.

5. A method for editing document layout, the method comprising the steps of:
extracting the distances between adjacent objects on a document;
collecting the plurality of distances into one or a plurality of groups on the basis of the difference between the plurality of distances extracted by the extracting unit;
unifying the distances collected by the collecting unit to a representative value; and
changing the layout of the objects so that the distances between the adjacent objects on the document become the representative value corresponding to the distances.

6. A computer-readable storage medium storing a computer-executable process, the computer-executable process causing a computer to implement a method comprising:
extracting the distances between adjacent objects on a document;
collecting the plurality of distances into one or a plurality of groups on the basis of the difference between the plurality of distances extracted by the extracting unit;
unifying the distances collected by the collecting unit to a representative value; and
changing the layout of the objects so that the distances between the adjacent objects on the document become the representative value corresponding to the distances.
